(19) United States
(12) Patent Application Publication
(10) Pub. No.: US 2026/0075654 A1
(43) Pub. Date: Mar. 12, 2026

(54) METHOD AND APPARATUS FOR MANAGING BEAM IN WIRELESS COMMUNICATION SYSTEM

(71) Applicant: ELECTRONICS AND TELECOMMUNICATIONS RESEARCH INSTITUTE, Daejeon (KR)

(72) Inventors: Jung-Bin KIM, Daejeon (KR); Pansoo KIM, Daejeon (KR); Hee Wook KIM, Daejeon (KR); Gyeongrae IM, Daejeon (KR); Sung-Hyun MOON, Daejeon (KR)

(73) Assignee: ELECTRONICS AND TELECOMMUNICATIONS RESEARCH INSTITUTE, Daejeon (KR)

(21) Appl. No.: 19/320,150

(22) Filed: Sep. 5, 2025

(30) Foreign Application Priority Data
Sep. 6, 2024 (KR) 10-2024-0121919
Sep. 30, 2024 (KR) 10-2024-0133028
Aug. 28, 2025 (KR) 10-2025-0121414
Aug. 28, 2025 (KR) 10-2025-0121468

(51) Int. Cl. H04W 74/0833; H04B 7/06; H04W 74/00

(52) U.S. Cl. CPC H04W 74/0833; H04B 7/06952; H04W 74/004

(57) ABSTRACT

A method of a terminal may comprise: receiving a synchronization signal block (SSB) from a satellite through a first beam including two or more narrow beams; receiving system information (SI) through the first beam based on the received SSB; identifying a first narrow beam in which the terminal is located among the two or more narrow beams based on first information included in the received SI; and initiating a random access channel (RACH) procedure based on initial access information of the first narrow beam included in the SI.

### CROSS-REFERENCE TO RELATED APPLICATIONS

This application claims priority to Korean Patent Applications No. 10-2024-0121919, filed on Sep. 6, 2024, No. 10-2024-0133028, filed on Sep. 30, 2024, No. 10-2025-0121414, filed on Aug. 28, 2025, and No. 10-2025-0121468, filed on Aug. 28, 2025, with the Korean Intellectual Property Office (KIPO), the entire contents of which are hereby incorporated by reference.

### BACKGROUND

### 1. Technical Field

The present disclosure relates to a technique for beam management in a wireless communication system, and more particularly, to a technique for identifying beams in a wireless communication system.

### 2. Related Art

Wireless communication systems initially primarily supported voice communication, but have gradually evolved to accommodate data communication. In such systems, data transmission has progressed to enable faster transfer of larger volumes of data.

In a wireless communication system, during data communication, a transmission node may encode and modulate data for transmission. A reception node may receive the encoded and modulated data from the transmission node and may obtain the transmitted data by performing decoding and demodulation on the received data.

In general, a reference signal (RS) may refer to a signal known to both the transmission node and the reception node. Among various types of RSs used in wireless communication systems, a demodulation reference signal (DMRS) may be employed. The DMRS may be a signal transmitted to assist the reception node in demodulating the data received from the transmission node. When data is transmitted together with the DMRS, the reception node may identify a wireless channel state based on the received DMRS. The reception node may then demodulate the data based on the identified channel state.

Beamforming has been adopted as one method for enabling a transmission node to transmit larger volumes of data to a reception node. Beamforming may involve transmitting data using multiple-input multiple-output (MIMO) antennas. In a MIMO configuration, the transmission node may transmit data to the reception node through a beam formed by multiplying a data vector to be transmitted with a precoding matrix.

On the other hand, in a wireless communication system, a transmission node may simultaneously transmit data to reception nodes located in different spaces through multiple spatial beams formed by an analog beamforming scheme without using a precoding matrix. The transmission node may also form beams with different shapes and sizes when forming beams in the same area. In other words, beams formed in the same area may be different beams.

The reception node may receive the data (or data vector) and the DMRS through the beam formed by the transmission node. The reception node may determine the channel state based on the DMRS and may demodulate the data based on the determined channel state.

Meanwhile, non-terrestrial networks (NTNs) have been introduced to enable wireless communication systems to provide services over broader geographic areas. An NTN may reduce coverage shadow areas of terminals by transmitting signals from high-altitude platforms such as satellites and may offer wider coverage compared to terrestrial networks (TNs). In an NTN, signals may be transmitted to terminals via satellites, high-altitude platforms, and/or drones. For example, when a satellite transmits signals, beams for covering narrow areas and beams for covering a wide area may coexist. Additionally, the narrow-area beams may be transmitted within a wide-area beam.

A terminal operating in an NTN in which narrow beams and wide beams are overlapped and coexist may need to distinguish between the narrow beams and the wide beams. This is because, if the terminal initially accesses the network within the coverage area of a wide beam and subsequently communicates through a narrow beam, a failure to distinguish between the wide beam and the narrow beam may cause communication delay and increased power consumption of the terminal.

### SUMMARY

The present disclosure is directed to providing methods and apparatus for a terminal to identify beams in a wireless communication system using beams of different sizes, thereby resolving the above-described problems.

A method of a terminal, according to an exemplary embodiment of the present disclosure, may comprise: receiving a synchronization signal block (SSB) from a satellite through a first beam including two or more narrow beams; receiving system information (SI) through the first beam based on the received SSB; identifying a first narrow beam in which the terminal is located among the two or more narrow beams based on first information included in the received SI; and initiating a random access channel (RACH) procedure based on initial access information of the first narrow beam included in the SI.

The first information may include at least one of: a number of the two or more narrow beams included in the first beam, or a reference location corresponding to each of the two or more narrow beams included in the first beam.

The reference location may be represented by center coordinates of a service area formed by each of the two or more narrow beams.

The initial access information may include at least one of: a RACH preamble set or a RACH occasion (RO) group available for each of the two or more narrow beams.

RACH preamble sets respectively corresponding to the two or more narrow beams may include different RACH preamble sequences, and RO groups respectively corresponding to the two or more narrow beams may include different RO resources.

The initiating of the RACH procedure may further comprise: selecting a RACH preamble sequence from a RACH preamble set corresponding to the first narrow beam; and transmitting a RACH preamble generated using the selected random RACH preamble sequence to the satellite in one RO of a RO group corresponding to the first narrow beam.

The SI may be one of a system information block 1 (SIB1) or a system information block 19 (SIB19).

The method may further comprise: estimating a location of the terminal based on information received from a plurality of satellites of a global positioning system (GPS), wherein the identifying of the first narrow beam may comprise: comparing reference locations respectively corresponding to the two or more narrow beams included in the first information with the estimated location of the terminal; and identifying a narrow beam corresponding to a reference location closest to the location of the terminal as the first narrow beam.

A method of a terminal, according to an exemplary embodiment of the present disclosure, may comprise: receiving a synchronization signal block (SSB) from a satellite through a first beam including two or more narrow beams; receiving system information (SI) through a first narrow beam having a greatest reception signal strength among the two or more narrow beams based on the received SSB; and initiating a random access channel (RACH) procedure based on initial access information of the first narrow beam included in the received SI.

The initial access information may include at least one of: a RACH preamble set or a RACH occasion (RO) group available for each of the two or more narrow beams.

RACH preamble sets respectively corresponding to the two or more narrow beams may include different RACH preamble sequences, and RO groups respectively corresponding to the two or more narrow beams may include different RO resources.

The initiating of the RACH procedure may further comprise: selecting a RACH preamble sequence from a RACH preamble set corresponding to the first narrow beam; and transmitting a RACH preamble generated using the selected random RACH preamble sequence to the satellite in one RO of a RO group corresponding to the first narrow beam.

A terminal, according to an exemplary embodiment of the present disclosure, may comprise at least one processor, wherein the at least one processor may cause the terminal to perform: receiving a synchronization signal block (SSB) from a satellite through a first beam including two or more narrow beams; receiving system information (SI) through the first beam based on the received SSB; identifying a first narrow beam in which the terminal is located among the two or more narrow beams based on first information included in the received SI; and initiating a random access channel (RACH) procedure based on initial access information of the first narrow beam included in the SI.

The first information may include at least one of: a number of the two or more narrow beams included in the first beam, or a reference location corresponding to each of the two or more narrow beams included in the first beam.

The reference location may be represented by center coordinates of a service area formed by each of the two or more narrow beams.

The initial access information may include at least one of: a RACH preamble set or a RACH occasion (RO) group available for each of the two or more narrow beams.

RACH preamble sets respectively corresponding to the two or more narrow beams may include different RACH preamble sequences, and RO groups respectively corresponding to the two or more narrow beams may include different RO resources.

In the initiating of the RACH procedure, the at least one processor may further cause the terminal to perform: selecting a RACH preamble sequence from a RACH preamble set corresponding to the first narrow beam; and transmitting a RACH preamble generated using the selected random RACH preamble sequence to the satellite in one RO of a RO group corresponding to the first narrow beam.

The SI may be one of a system information block 1 (SIB1) or a system information block 19 (SIB19).

The at least one processor may further cause the terminal to perform: estimating a location of the terminal based on information received from a plurality of satellites of a global positioning system (GPS), and in the identifying of the first narrow beam, the at least one processor may further cause the terminal to perform: comparing reference locations respectively corresponding to the two or more narrow beams included in the first information with the estimated location of the terminal; and identifying a narrow beam corresponding to a reference location closest to the location of the terminal as the first narrow beam.

According to exemplary embodiments of the present disclosure, in an NTN, a satellite transmits SIB1 and/or SIB19 including RACH-related information of respective narrow beams included in a wide beam to a terminal, thereby providing an advantage in that both the terminal and the satellite can identify a narrow beam to which the terminal belongs. By allowing the terminal to connect to the satellite through the narrow beam after acquiring synchronization with the satellite through the wide beam, service delay for the terminal can be prevented. This can improve the quality of service of the terminal. Furthermore, since a procedure in which the terminal re-searches the narrow beam of the satellite does not occur, there is an advantage of reducing power consumption of the terminal.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a sequence diagram illustrating a case in which a terminal performs a RACH access procedure with a base station in a wireless communication system.

FIG. 4 is a conceptual diagram illustrating a first exemplary embodiment of service areas formed by beams of a satellite in an NTN.

FIG. 5 is a conceptual diagram illustrating a second exemplary embodiment of service areas formed by beams of a satellite in an NTN.

FIG. 6 is a conceptual diagram illustrating a first exemplary embodiment of an NTN.

FIG. 7 is a conceptual diagram illustrating a second exemplary embodiment of an NTN.

FIG. 8 is a sequence chart illustrating a first exemplary embodiment in which a RACH access procedure is initiated through a narrow beam of a satellite, based on a signal broadcast through a wide beam by the satellite in an NTN.

FIG. 9 is a flowchart of a first exemplary embodiment in which a terminal performs a RACH access procedure through a narrow beam of a satellite by receiving a signal broadcast through a wide beam of the satellite in an NTN.

FIG. 10 is a sequence chart illustrating a second exemplary embodiment for a case where a terminal initiates a RACH access procedure through a narrow beam of a satellite based on a signal broadcast through a wide beam of the satellite in an NTN.

FIG. 11 is a flowchart of a second exemplary embodiment in which a terminal performs a RACH access procedure through a narrow beam of a satellite by receiving a signal broadcast through a wide beam of the satellite in an NTN.

FIG. 12 is a conceptual diagram illustrating a REG-based CORESET 0 in one slot.

FIG. 13 is a sequence chart illustrating a procedure in which a terminal acquires minimum system information from a base station when power of the terminal is turned on according to an exemplary embodiment of the present disclosure.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g. 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

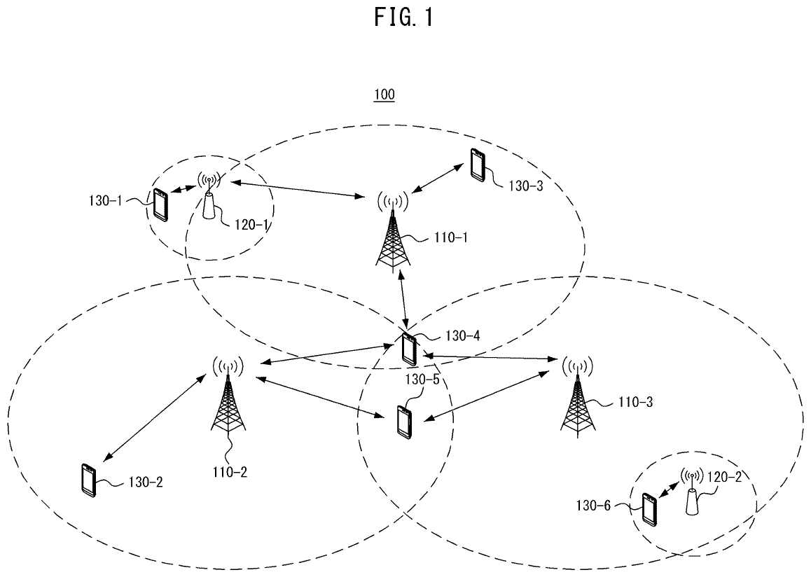

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHZ, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

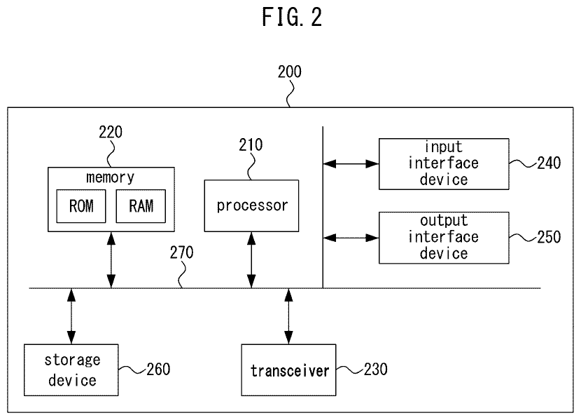

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

In the present disclosure, a phrase including “when ˜” may be expressed as a phrase including “based on ˜” or a phrase including “in response to ˜”. In other words, a phrase including “when ˜” may be interpreted as the same as or similar to a phrase including “based on ˜” or a phrase including “in response to ˜”.

Hereinafter, a procedure in which a terminal of a wireless communication system accesses a base station is described.

When the terminal of the wireless communication system is powered on, the terminal may search all available frequency bands and receive a synchronization signal (SS)/physical broadcast channel (PBCH) block. In 5G NR, since an SS/PBCH block is transmitted through four consecutive OFDM symbols, the SS/PBCH block may also be referred to as an ‘SS/PBCH’, ‘SS/PBCH block’, or a ‘synchronization signal block (SSB)’. The SS may include a primary synchronization signal (PSS) and a secondary synchronization signal (SSS).

Upon receiving the PSS, the terminal may estimate a cell group identifier (ID) from the PSS and may receive the SSS based on the PSS. By receiving the PSS and SSS, the terminal may acquire a cell identity (ID). Here, a cell may be defined differently depending on a configuration scheme of a base station and a frequency band used by the base station, but in the present disclosure, a cell is assumed to refer to a base station for convenience of description. The cell ID acquired based on the PSS and SSS may be a physical cell identity (PCI). In addition, by receiving the PSS and SSS, the terminal may acquire time and frequency synchronization with the base station.

The terminal may identify a location at which a PBCH is transmitted based on the PSS/SSS and may receive the PBCH. According to the 5G NR specifications, the SS and PBCH may be modulated using a quadrature phase shift keying (QPSK) scheme and coded using a polar code. Therefore, the terminal may demodulate the PBCH based on the QPSK scheme and may decode the PBCH using a polar decoding scheme. The base station may broadcast a master information block (MIB), which is a part of system information used in the cell, through the PBCH. The base station may also transmit a DMRS for demodulating the MIB together with the MIB through the PBCH. Therefore, the terminal may estimate a channel by using the DMRS received through the PBCH and may decode the MIB using the estimated channel information.

The MIB broadcast by the base station may include a current system frame number (SFN), information on a transmission periodicity of the SSB and the number of SSB transmissions, and system information block 1 (SIB1)-related information. The SIB1-related information may be PDCCH configuration information (e.g. pdcch-ConfigSIB1) including information on a subcarrier spacing (SCS) of SIB1 and information on a physical downlink control channel (PDCCH) search space. The PDCCH search space information may indicate a control resource set (CORESET) 0 in which a PDCCH is transmitted, and the SIB1 may be transmitted on a physical downlink shared channel (PDSCH).

The terminal may receive a PDCCH in a time and frequency resource of the CORESET 0. The PDCCH may be a channel on which downlink control information (DCI) is transmitted. The DCI transmitted through the PDCCH in the time and frequency resource of the CORESET 0 may indicate information on a resource of the PDSCH on which the SIB1 is transmitted and information required for demodulating the PDSCH (e.g. modulation and coding scheme (MCS)). The terminal may receive the SIB1 transmitted on the PDSCH based on the received DCI. The SIB1 may include a public land mobile network identity (PLMN ID), a tracking area code (TAC), cell selection parameters, scheduling information for SIB2 to SIBn, and random access channel (RACH) configuration information. The terminal may select the base station (or cell) based on the MIB and the SIB and may attempt initial access to the selected base station, for example, through a random access (RA) procedure.

The DCI for indicating the SIB1 may include information such as a frequency resource, time resource, and MCS of the PDSCH on which the SIB1 is transmitted, and a cyclic redundancy check (CRC) for error detection of the information included in the DCI. The CRC included in the DCI may be scrambled by one of various radio network temporary identifiers (RNTIs), and the CRC appended to the DCI for indicating the SIB1 may be scrambled using a system information (SI)-RNTI (SI-RNTI). In other words, the base station may transmit the DCI to the terminal on the PDCCH by scrambling the CRC of the DCI with the SI-RNTI. In 5G NR, the DCI transmitted by scrambling the CRC of the DCI with the SI-RNTI may have a DCI format 1_0.

The terminal may receive the DCI, that indicates the resource of the PDSCH on which the SIB1 is transmitted, on the PDCCH. More specifically, the terminal may descramble the DCI received on the PDCCH using the SI-RNTI and may determine that the DCI for indicating the SIB1 (e.g. DCI format 1_0) is received when a CRC check of the DCI is successfully verified. The terminal may receive the SIB1 on the PDSCH based on the received DCI format 1_0.

The DCI format 1_0 for indicating SIB1 may be configured as shown in Table 1 below.

TABLE 1

| Field | Bits |
|---|---|
| Frequency domain resource assignment | Variable |
| Time domain resource assignment | 4 |
| Virtual Resource Block (VRB)- | 1 |
| to-Physical Resource Block (PRB) | |
| mapping | |
| MCS | 5 |
| Redundancy version | 2 |
| System information indicator | 1 |
| Reserved | 14 |

Table 1 illustrates only fields of the DCI format 1_0. A CRC may be appended to the fields of the DCI format 1_0. In other words, the fields of Table 1 and the CRC may be serially concatenated and transmitted. In this case, the CRC may be scrambled using the SI-RNTI and transmitted together with the DCI format 1_0 illustrated in Table 1.

Based on the above description, the terminal may perform an RA procedure with the base station.

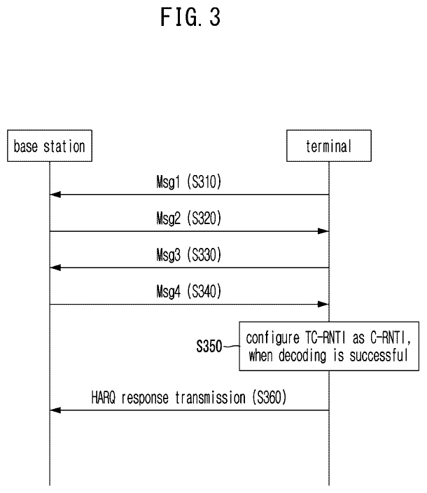

FIG. 3 is a sequence diagram illustrating a case in which a terminal performs a RACH access procedure with a base station in a wireless communication system.

Prior to referring to FIG. 3, a terminal may include all or a part of the components of the communication node 200 illustrated in FIG. 2. The terminal may further include various devices for user convenience in addition to the components of the communication node 200 described in FIG. 2. For example, the terminal may further include various sensors, a camera device, user interface devices, and/or a global positioning system (GPS) receiver. The terminal may also include a power supply device such as a battery in addition to the components of the communication node 200 illustrated in FIG. 2. A base station may also include all or a part of the components of the communication node 200 illustrated in FIG. 2. The base station may further include an interface (e.g. a backhaul interface) for connection with an upper node of the base station in addition to the components of the communication node 200 illustrated in FIG. 2. In a case in which the base station is functionally split, the base station may further include a fronthaul interface for communication with the functionally split components.

The RACH access procedure illustrated in FIG. 3 may correspond to a four-step (4-step) access procedure. Although a two-step access procedure may also be used, a four-step access procedure may be performed for initial access. The RACH access procedure may be classified into a contention-based random access (CBRA) scheme and a contention-free random access (CFRA) scheme. The RACH access procedure for initial access may be a CBRA procedure. Therefore, in FIG. 3, the four-step RACH access procedure using the CBRA scheme is described. The four-step RACH access procedure may be performed not only for initial access but also for various cases. For example, the four-step RACH access procedure may be performed when the terminal experiences a radio link failure (RLF) and needs to perform reconnection with the base station, when the terminal performs a general handover, and/or when a radio resource control (RRC) reestablishment is triggered by the base station.

In step S310, the terminal may transmit a first message (Msg1) to the base station based on an SIB1 obtained during a synchronization procedure with the base station. The terminal may transmit the first message in a RACH occasion (RO) obtained from the SIB1. In this case, the first message may be a RACH preamble. Accordingly, the base station may receive the first message from the terminal in step S310.

In step S320, the base station may transmit a second message (Msg2) to the terminal in response to the reception of the first message. The second message may be a random access response (RAR) as a response to the RACH preamble. The RAR may be medium access control (MAC) information. The RAR may include uplink (UL) grant information, timing advance (TA) information, and a temporary cell-RNTI (TC-RNTI). The information included in the RAR may be transmitted to the terminal on a PDSCH. Therefore, a PDCCH for indicating the PDSCH may be transmitted to the terminal prior to the PDSCH. In other words, the base station may first transmit a DCI to the terminal on the PDCCH. Thereafter, the base station may transmit the RAR to the terminal on the PDSCH indicated by the DCI transmitted on the PDCCH. In this case, the PDCCH may indicate a resource of the PDSCH carrying the RAR and may include information for demodulating and decoding the PDSCH. Accordingly, in step S320, the terminal may receive the second message from the base station.

In step S330, the terminal may transmit a third message (Msg3) to the base station based on the second message received from the base station. In other words, the terminal may transmit the third message on a physical uplink shared channel (PUSCH) allocated by the UL grant information included in the second message. The third message may be RRC connection request information. Accordingly, in step S330, the base station may receive the third message including the RRC connection request information from the terminal.

In step S340, the base station may transmit a fourth message (Msg4) to the terminal in response to the reception of the third message. The fourth message may include RRC connection setup information. The fourth message may also be transmitted to the terminal on a PDCCH and a PDSCH. More specifically, the base station may first transmit a DCI to the terminal through the PDCCH, the DCI including information on a resource of the PDSCH on which the fourth message is transmitted and information for demodulating and decoding the PDSCH. Thereafter, the base station may transmit the RRC connection setup information to the terminal on the PDSCH indicated by the DCI transmitted on the PDCCH. In step S340, the terminal may receive the fourth message from the base station.

In step S350, the terminal may receive the fourth message and may demodulate and decode the received fourth message. When the demodulation and decoding of the fourth message are successful, the terminal may configure the temporary identifier TC-RNTI as a cell-RNTI (C-RNTI).

In step S360, the terminal may generate a hybrid automatic repeat request (HARQ) response for the fourth message and transmit the HARQ response to the base station. When the demodulation and decoding are successful, the terminal may transmit acknowledgment (ACK) information as the HARQ response to the base station. On the other hand, when the demodulation and decoding of the fourth message fail within a time duration defined by a contention resolution timer, the terminal may determine that the RACH access procedure has failed. When the terminal determines that the RACH access procedure has failed, the terminal may perform the procedure again starting from step S310.

Meanwhile, in an NTN, a satellite may transmit a plurality of beams to the ground and may define areas covered by the respective beams as service areas. A service area formed by each of the satellite beams in the NTN may be referred to as a footprint. In this case, a situation may exist where a service area is provided by a wide beam formed by the satellite and service areas are provided by narrow beams coexist. Hereinafter, cases in which a service area formed by a wide beam and service areas formed by narrow beams coexist are described with reference to the accompanying drawings.

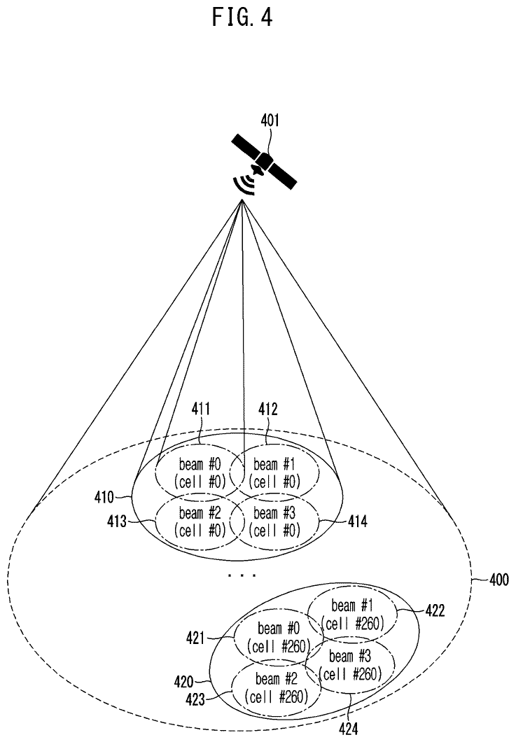

FIG. 4 is a conceptual diagram illustrating a first exemplary embodiment of service areas formed by beams of a satellite in an NTN.

Referring to FIG. 4, an overall service area 400 provided by a satellite 401 may be composed of service areas 411, 412, 413, 414, . . . , 421, 422, 423, 424, which are formed through a plurality of narrow beams. As illustrated in FIG. 4, the service area 411 configured by a narrow beam #0 in a cell #0, the service area 412 configured by a narrow beam #1 in the cell #0, the service area 413 configured by a narrow beam #2 in the cell #0, and the service area 414 configured by a narrow beam #3 in the cell #0 may together constitute a service area 410 formed by a single wide beam.

In addition, the service area 421 configured by a narrow beam #0 in a cell #260, the service area 422 configured by a narrow beam #1 in the cell #260, the service area 423 configured by a narrow beam #2 in the cell #260, and the service area 424 configured by a narrow beam #3 in the cell #260 may constitute another service area 420 formed by another wide beam.

As described above, the satellite 401 may transmit multiple beams, and the beams may be allocated to spatially different regions within the overall service area 400. More specifically, the satellite 401 may allocate narrow beams to different service areas 411, 412, 413, 414, . . . , 421, 422, 423, 424 in the overall service area 400. Additionally, the satellite 401 may allocate a wide beam to the specific service area 410 in the overall service area 400. As illustrated in FIG. 4, the service area 410 formed by the wide beam may be a service area overlapping with the service areas 411, 412, 413, 414 formed by the plurality of narrow beams. The service area 410 formed by the wide beam may correspond to a case in which the narrow beams cover adjacent service areas 411 through 414. In other words, the service area 410 formed by the wide beam may be configured to include geographically adjacent service areas 411 through 414.

As illustrated in FIG. 4, the satellite 401 may operate wide beams and narrow beams having different beam widths, and the wide beam may be composed of a plurality of narrow beams. When the satellite 401 provides services to a terminal using a narrow beam and a wide beam, the satellite 401 may transmit various broadcast signals required to be transmitted by the base station through the wide beam. For example, the satellite 401 may broadcast an SSB within the service area 410 formed by the wide beam by using the wide beam for SSB transmission. On the other hand, a PDCCH and a PDSCH for transmitting data to the terminal may be transmitted through a narrow beam corresponding to a service area where the terminal is located.

In addition, since the satellite 401 is subject to radio frequency (RF) transmission power limitations, when transmission of a wide beam is performed, transmission for narrow beams included in the wide beam may not be simultaneously performed. Therefore, when the wide beam is used, the transmission of narrow beams may be suspended, and when a narrow beam is used, the wide beam may not be used.

On the other hand, the wide beam may not be configured with geographically adjacent service areas as illustrated in FIG. 4.

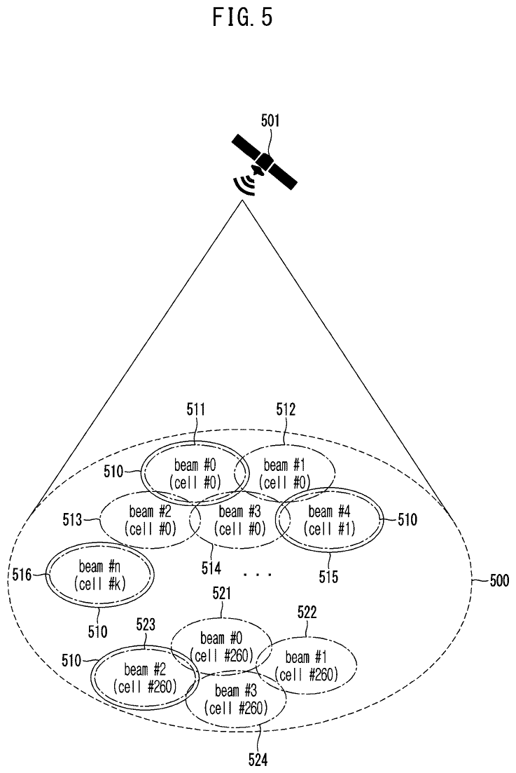

FIG. 5 is a conceptual diagram illustrating a second exemplary embodiment of service areas formed by beams of a satellite in an NTN.

Referring to FIG. 5, an overall service area 500 provided by a satellite 501 may be composed of service areas 511, 512, 513, 514, 515, 516, . . . , 521, 522, 523, 524, which are formed through a plurality of narrow beams.

Since cells and beams for the respective service areas 511, 512, 513, 514, 515, 516, . . . 521, 522, 523, 524 illustrated in FIG. 5 are depicted in the drawing, a detailed description thereof is omitted. Meanwhile, the service area 510 formed by a wide beam in FIG. 5 may be composed of narrow beams corresponding to the service areas 511, 515, 516, and 523, which are not geographically adjacent.

In the case of FIG. 5 as well, the satellite 501 may operate narrow beams and wide beams having different beam widths, and the wide beam may be composed of a plurality of narrow beams. As described above with reference to FIG. 4, the satellite 501 illustrated in FIG. 5 may also broadcast various broadcast signals (e.g. SSB) within the service area 510 formed by the wide beam using the wide beam. On the other hand, a PDCCH and a PDSCH for transmitting data to the terminal may be transmitted through a narrow beam corresponding to a service area where the terminal is located.

As illustrated in FIGS. 4 and 5, the coverage of the wide beam may be composed of narrow beams corresponding to geographically adjacent service areas, narrow beams corresponding to geographically non-adjacent service areas, or may be configured in other forms.

As described with reference to FIGS. 4 and 5, when a specific broadcast signal (e.g. SSB) is transmitted through a wide beam and a PDCCH and a PDSCH for a terminal are transmitted through a narrow beam, the terminal desiring to initially access the NTN may access the NTN based on the SSB received through the wide beam. Thereafter, the terminal needs to be served through the PDCCH and PDSCH transmitted through the narrow beam. However, if the terminal accesses the NTN through the wide beam, the terminal has a problem in that the terminal cannot identify a narrow beam in which the terminal is located.

Therefore, after initial access, the terminal may perform operations such as channel measurement on narrow beams in order to identify the narrow beam to which the terminal belongs. In other words, to identify the narrow beam, the terminal may experience power consumption due to the additional channel measurement operation on narrow beams after initial access, and a time delay may occur before the terminal receives service through the narrow beam. Therefore, a method for identifying the narrow beam to which the terminal belongs during an initial access phase is required.

In FIGS. 4 and 5, only a single satellite is described in the NTN. The NTN may include two or more satellites and may be connected to and communicate with a terrestrial network (TN). Hereinafter, the overall configuration and operation of the NTN are described.

The NTN may operate based on LTE technology, NR technology, and/or 6G technology. The NTN may support communication not only in a frequency band below 6 GHz but also in a frequency band above 6 GHz. A 4G communication network may support communication in a frequency band below 6 GHz. A 5G communication network may support communication not only in a frequency band below 6 GHz but also in a frequency band above 6 GHz. The communication network to which the exemplary embodiments according to the present disclosure are applied is not limited to the content described below, and the exemplary embodiments according to the present disclosure may be applied to various communication networks. Herein, the term ‘communication network’ may be used interchangeably with ‘communication system’.

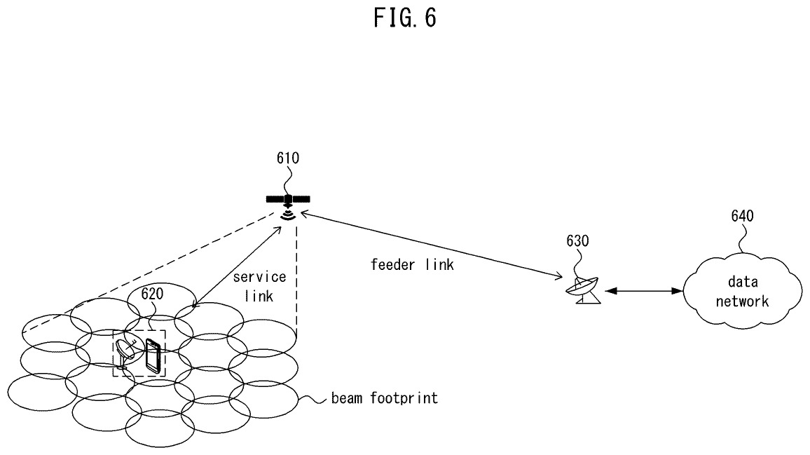

FIG. 6 is a conceptual diagram illustrating a first exemplary embodiment of an NTN.

Referring to FIG. 6, an NTN may include a satellite 610, a communication node 620, a gateway 630, a data network 640, and the like. The NTN shown in FIG. 6 may be a transparent payload-based NTN. The satellite 610 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS).

The communication node 620 may include a communication node (e.g. a user equipment (UE) or a terminal) located on a terrestrial site and a communication node (e.g. an airplane, a drone) located on a non-terrestrial space. A service link may be established between the satellite 610 and the communication node 620, and the service link may be a radio link. The satellite 610 may provide communication services to the communication node 620 using one or more beams. The shape of a footprint of the beam of the satellite 610 may be elliptical.

The communication node 620 may perform communications (e.g. downlink communication and uplink communication) with the satellite 610 using LTE technology and/or NR technology. The communications between the satellite 610 and the communication node 620 may be performed using an NR-Uu interface. When dual connectivity (DC) is supported, the communication node 620 may be connected to other base stations (e.g. base stations supporting LTE and/or NR functionality) as well as the satellite 610, and perform DC operations based on the techniques defined in the LTE and/or NR specifications.

The gateway 630 may be located on a terrestrial site, and a feeder link may be established between the satellite 610 and the gateway 630. The feeder link may be a radio link. The gateway 630 may be referred to as a ‘non-terrestrial network (NTN) gateway’. The communications between the satellite 610 and the gateway 630 may be performed based on an NR-Uu interface or a satellite radio interface (SRI). The gateway 630 may be connected to the data network 640. There may be a ‘core network’ between the gateway 630 and the data network 640. In this case, the gateway 630 may be connected to the core network, and the core network may be connected to the data network 640. The core network may support the NR technology. For example, the core network may include an access and mobility management function (AMF), a user plane function (UPF), a session management function (SMF), and the like. The communications between the gateway 630 and the core network may be performed based on an NG-C/U interface.

Alternatively, a base station and the core network may exist between the gateway 630 and the data network 640. In this case, the gateway 630 may be connected with the base station, the base station may be connected with the core network, and the core network may be connected with the data network 640. The base station and core network may support the NR technology. The communications between the gateway 630 and the base station may be performed based on an NR-Uu interface, and the communications between the base station and the core network (e.g. AMF, UPF, SMF, and the like) may be performed based on an NG-C/U interface.

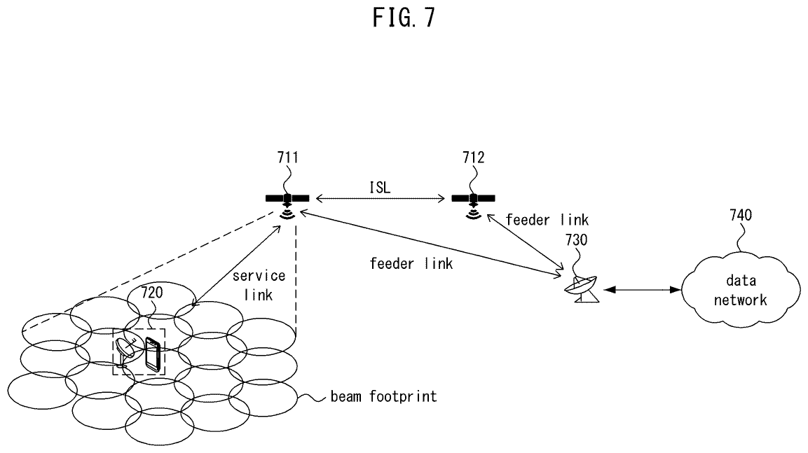

FIG. 7 is a conceptual diagram illustrating a second exemplary embodiment of an NTN.

Referring to FIG. 7, an NTN may include a first satellite 711, a second satellite 712, a communication node 720, a gateway 730, a data network 740, and the like. The NTN shown in FIG. 7 may be a regenerative payload-based NTN. For example, each of the satellites 711 and 712 may perform a regenerative operation (e.g. demodulation, decoding, re-encoding, re-modulation, and/or filtering operation) on a payload received from other entities (e.g. the communication node 720 or the gateway 730), and transmit the regenerated payload.

Each of the satellites 711 and 712 may be a LEO satellite, a MEO satellite, a GEO satellite, a HEO satellite, or a UAS platform. The UAS platform may include a HAPS. The satellite 711 may be connected to the satellite 712, and an inter-satellite link (ISL) may be established between the satellite 711 and the satellite 712. The ISL may operate in an RF frequency band or an optical band. The ISL may be established optionally. The communication node 720 may include a terrestrial communication node (e.g. UE or terminal) and a non-terrestrial communication node (e.g. airplane or drone). A service link (e.g. radio link) may be established between the satellite 711 and communication node 720. The satellite 711 may provide communication services to the communication node 720 using one or more beams.

The communication node 720 may perform communications (e.g. downlink communication or uplink communication) with the satellite 711 using LTE technology and/or NR technology. The communications between the satellite 711 and the communication node 720 may be performed using an NR-Uu interface. When DC is supported, the communication node 720 may be connected to other base stations (e.g. base stations supporting LTE and/or NR functionality) as well as the satellite 711, and may perform DC operations based on the techniques defined in the LTE and/or NR specifications.

The gateway 730 may be located on a terrestrial site, a feeder link may be established between the satellite 711 and the gateway 730, and a feeder link may be established between the satellite 712 and the gateway 730. The feeder link may be a radio link. When the ISL is not established between the satellite 711 and the satellite 712, the feeder link between the satellite 711 and the gateway 730 may be established mandatorily.

The communications between each of the satellites 711 and 712 and the gateway 730 may be performed based on an NR-Uu interface or an SRI. The gateway 730 may be connected to the data network 740. There may be a core network between the gateway 730 and the data network 740. In this case, the gateway 730 may be connected to the core network, and the core network may be connected to the data network 740. The core network may support the NR technology. For example, the core network may include AMF, UPF, SMF, and the like. The communications between the gateway 730 and the core network may be performed based on an NG-C/U interface.

Alternatively, a base station and the core network may exist between the gateway 730 and the data network 740. In this case, the gateway 730 may be connected with the base station, the base station may be connected with the core network, and the core network may be connected with the data network 740. The base station and the core network may support the NR technology. The communications between the gateway 730 and the base station may be performed based on an NR-Uu interface, and the communications between the base station and the core network (e.g. AMF, UPF, SMF, and the like) may be performed based on an NG-C/U interface.

Meanwhile, entities (e.g. satellites, communication nodes, gateways, etc.) constituting the NTNs shown in FIGS. 6 and 7 may be configured as shown in FIG. 2.

Meanwhile, scenarios in the NTN may be defined as shown in Table 2 below.

TABLE 2

| | NTN shown | NTN shown |
|---|---|---|
| | in FIG. 1 | in FIG. 2 |
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 610 in the NTN shown in FIG. 6 is a GEO satellite (e.g. a GEO satellite that supports a transparent function), this may be referred to as ‘scenario A’. When the satellites 711 and 712 in the NTN shown in FIG. 7 are GEO satellites (e.g. GEOs that support a regenerative function), this may be referred to as ‘scenario B’.

When the satellite 610 in the NTN shown in FIG. 6 is an LEO satellite with steerable beams, this may be referred to as ‘scenario C1’. When the satellite 610 in the NTN shown in FIG. 6 is an LEO satellite having beams moving with the satellite, this may be referred to as ‘scenario C2’. When the satellites 711 and 712 in the NTN shown in FIG. 7 are LEO satellites with steerable beams, this may be referred to as ‘scenario D1’. When the satellites 711 and 712 in the NTN shown in FIG. 7 are LEO satellites having beams moving with the satellites, this may be referred to as ‘scenario D2’. Parameters for the scenarios defined in Table 2 may be defined as shown in Table 3 below.

TABLE 3

| | Scenarios A and B | | Scenarios C and D | |
|---|---|---|---|---|
| Altitude | 35,786 | km | 600 | km |
| | | | 1,200 | km |

| Spectrum (service link) | <6 GHz (e.g. 2 GHz) | | |
|---|---|---|---|
| | >6 GHz (e.g. DL 20 GHz, UL 30 GHz) | | |
| Maximum channel bandwidth | 30 MHz for band <6 GHz | | |
| capability (service link) | 1 GHz for band >6 GHz | | |
| Maximum distance between | 40,581 | km | 1,932 km (altitude of 600 km) |
| satellite and communication | | | 3,131 km (altitude of 1,200 km) |
| node (e.g. UE) at the | | | |
| minimum elevation angle | | | |
| Maximum round trip delay | Scenario A: 541.46 ms | | Scenario C: (transparent |
| (RTD) (only propagation | (service and feeder links) | | payload: service and |
| delay) | Scenario B: 270.73 ms | | feeder links) |
| | (only service link) | | −5.77 ms (altitude of 60 0 km) |
| | | | −41.77 ms (altitude of 1,200 km) |
| | | | Scenario D: (regenerative |
| | | | payload: only service link) |
| | | | −12.89 ms (altitude of 600 km) |
| | | | −20.89 ms (altitude of 1,200 km) |
| Maximum delay variation | 16 | ms | 4.44 ms (altitude of 600 km) |
| within a single beam | | | 6.44 ms (altitude of 1,200 km) |
| Maximum differential | 10.3 | ms | 3.12 ms (altitude of 600 km) |
| delay within a cell | | | 3.18 ms (altitude of 1,200 km) |

| | |
|---|---|
| Service link | NR defined in 3GPP |
| Feeder link | Radio interfaces defined in 3GPP or non-3GPP |

In addition, in the scenarios defined in Table 2, delay constraints may be defined as shown in Table 4 below.

TABLE 4

| | Scenario A | Scenario B | Scenario C | | Scenario D | |
|---|---|---|---|---|---|---|
| Satellite altitude | 35,786 km | | 600 km | | | |
| Maximum RTD in a | 541.75 ms | 270.57 ms | 28.41 | ms | 12.88 | ms |
| radio interface | (worst case) | | | | | |
| between base | | | | | | |
| station and UE | | | | | | |
| Minimum RTD in a | 477.14 ms | 238.57 ms | 8 | ms | 4 | ms |
| radio interface | | | | | | |
| between base | | | | | | |
| station and UE | | | | | | |

Hereinafter, the present disclosure describes a method by which a terminal initially accessing an NTN identifies a narrow beam to which the terminal belongs, and a method for providing the terminal with information on a relationship between a wide beam and a narrow beam in the NTN.

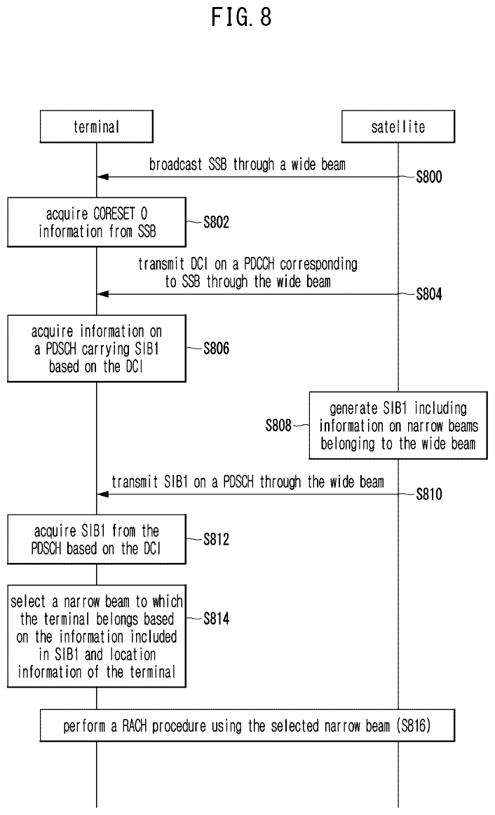

FIG. 8 is a sequence chart illustrating a first exemplary embodiment in which a RACH access procedure is initiated through a narrow beam of a satellite, based on a signal broadcast through a wide beam by the satellite in an NTN.

Prior to referring to FIG. 8, a terminal may include all or a part of the components of the communication node 200 illustrated in FIG. 2. The terminal may further include various devices for user convenience in addition to the components of the communication node 200 illustrated in FIG. 2. For example, the terminal may further include one or more of various sensors, a camera device, user interface devices, and a GPS receiver. In addition, the terminal may further include a power supply device such as a battery in addition to the components of the communication node 200 illustrated in FIG. 2.

A satellite illustrated in FIG. 8 may be a satellite that simply amplifies and transmits a signal (or data) transmitted to the terminal, or may be a satellite that reprocesses and amplifies a signal (or data) transmitted to the terminal. In addition, the satellite illustrated in FIG. 8 may include all or a part of the components illustrated in FIG. 2. The satellite illustrated in FIG. 8 may further include interfaces for processing the feeder link and inter-satellite link (ISL) described with reference to FIG. 6 and/or FIG. 7. The control operation of the satellite described in FIG. 8 may be directly controlled by a processor of the satellite, or may be controlled by a base station on the ground (not shown in the drawing), a gateway on the ground, and/or a specific node of a core network. Hereinafter, for convenience of description, it is assumed that the operation of the satellite illustrated in FIG. 8 is controlled by a processor of the satellite.

In step S800, the satellite may transmit an SSB to a service area covered by a wide beam through the wide beam. The SSB may be transmitted periodically. Step S800 in FIG. 8 may be understood as transmission of an SSB at a specific time within the periodic transmission of SSBs. A terminal that intends to access the NTN may receive the SSB transmitted by the satellite using a wide beam in step S800. As described above, the SSB may include a PSS and a SSS, and may include a PBCH.

In step S802, the terminal may acquire downlink synchronization with the satellite based on the received SSB, and may acquire a PCI. In addition, the terminal may demodulate and decode the PBCH included in the SSB to acquire configuration information on a CORESET 0 related to SIB1 transmission.

In step S804, the satellite may transmit a DCI on a PDCCH based on the CORESET 0 using the wide beam. In step S804, the terminal may receive the DCI transmitted on the PDCCH based on the CORESET 0.

In step S806, the terminal may acquire information on a PDSCH for SIB1 transmission based on the received DCI. The DCI may include information such as a time-frequency resource of the PDSCH for the SIB1 and an MCS of data transmitted through the PDSCH. The DCI may further include the information exemplified in Table 1 described above.

In step S808, the satellite may generate an SIB1 including information on narrow beams belonging to the wide beam. The information on the narrow beams belonging to the wide beam, which is included in the SIB1, may include one or more of an A1 field and an A2 field below. The A1 field and the A2 field may respectively include the following information.
A1 field: information on the number of narrow beams included within the wide beam
A2 field: information on a reference location corresponding to each of the narrow beams

A reference location of a beam may be, for example, a center location (or coordinates) of a service area formed by the beam. The SIB1 according to an exemplary embodiment of the present disclosure may further include the A1 field and the A2 field. When the SIB1 includes only information on a reference location corresponding to each of the narrow beams, that is, only the A2 field, the A1 field may be omitted. When the SIB1 includes only the A2 field, the terminal may identify the number of narrow beams included within the wide beam by counting the number of included reference location information elements. As another example, when the number of narrow beams included in a single wide beam is set to a fixed value in the system, the A1 field may be omitted.

When the SIB1 includes both the A1 field and the A2 field, the terminal may acquire the number of narrow beams based on the A1 field and may acquire the reference locations, which are the center locations of the respective multiple narrow beams, based on the A2 field. Accordingly, the terminal may acquire the center location for each of the narrow beams based on the A2 field included in the SIB1.

The information on the reference location corresponding to each of the narrow beams may be represented, for example, by x-axis and y-axis information. The x-axis and y-axis information may be location information comparable to information obtained by the GPS receiver of the terminal. The example of expressing the reference location corresponding to each of the narrow beams as x-axis and y-axis information is for ease of understanding of the present disclosure, and the reference location may also be expressed in another form, for example, in longitude/latitude information, or another form of information for specifying the location.

The information on narrow beams belonging to the wide beam, which is included in the SIB1, may further include information required for the terminal to perform initial access using each narrow beam, for example, to perform a RACH access procedure. In order for the terminal to perform the RACH access procedure, the SIB1 may include one or more of a B1 field and a B2 field below. The B1 field and the B2 field may include the following information, respectively.
B1 field: a RACH preamble set (or RACH preamble sequence set) to be used in each of the narrow beams included in the wide beam
B2 field: one or more RACH occasions (ROs) to be used in each of the narrow beams included in the wide beam, or an RO group to be used in each of the narrow beams included in the wide beam

The SIB1 may further include the B1 field and the B2 field. As another example, the SIB1 may include only the B1 field, or only the B2 field.

When the RACH access procedure is initiated, the terminal may select a RACH preamble set corresponding to a narrow beam to which the terminal belongs among the RACH preamble sets configured for the respective narrow beams included in the wide beam, which are provided by the SIB1. In other words, the terminal may identify a RACH preamble set for each of the narrow beams from the B1 field included in the SIB1 and may select a RACH preamble set corresponding to the narrow beam to which the terminal belongs. The terminal may arbitrarily select one RACH preamble sequence among RACH preamble sequences included in the selected RACH preamble set to generate a RACH preamble. In other words, by receiving the SIB1 according to the present disclosure, the terminal may identify RACH preamble sets differently configured for the respective narrow beams and, once the narrow beam to which the terminal belongs is identified, may select a RACH preamble set corresponding to the identified narrow beam. The terminal may arbitrarily select one of the RACH preamble sequences included in the selected RACH preamble set to generate the RACH preamble.

The RACH preamble may be transmitted in a RACH occasion (RO). The RO may refer to a time-frequency resource in which the RACH preamble is transmitted. The SIB1 according to the present disclosure may configure different ROs or RO groups for the respective narrow beams. In other words, the base station may configure different ROs or RO groups for the narrow beams using the B2 field included in SIB1.

For example, a case may be assumed in which the number of narrow beams included in a wide beam is three, and there is only one RO for each narrow beam. Under this assumption, an RO #1 of a first narrow beam, an RO #2 of a second narrow beam, and an RO #3 of a third narrow beam may be identified by different time-frequency resources. Therefore, once the terminal identifies a narrow beam to which it belongs, the terminal may transmit a RACH preamble using an RO corresponding to the identified narrow beam. When an RO group including two or more ROs is configured for each of the narrow beams, the terminal may select one RO from an RO group corresponding to the narrow beam to which the terminal belongs to transmit a RACH preamble. Accordingly, the SIB1 according to the present disclosure may include only the B1 field, only the B2 field, or both the B1 field and the B2 field.

In step S810, the satellite may transmit the SIB1 on a PDSCH using the wide beam. The SIB1 may be transmitted with a preconfigured periodicity. Step S810 in FIG. 8 may be understood as SIB1 transmission at a specific time within the periodic transmission of SIB1. The terminal may receive the SIB1 transmitted on the PDSCH using the wide beam based on the information acquired in step S806.

In step S812, the terminal may demodulate and decode the SIB1 received on the PDSCH based on the DCI received in step S804, and when decoding is successful, the terminal may acquire the SIB1. When decoding fails, the terminal may perform again from one of step S800, step S804, or step S810.

In step S814, the terminal may select a narrow beam to which the terminal belongs based on the information included in the SIB1 and location information of the terminal. A more detailed description of a method for selecting the narrow beam to which the terminal belongs is as follows.

The terminal may measure (or estimate) its own location using the GPS receiver. Since methods of measuring a location using a GPS receiver are well known, additional description is omitted herein. The location estimated by the terminal using the GPS receiver may be, for example, longitude and latitude information. The SIB1 may include information on a reference location for each of a plurality of narrow beams. As described above, a reference location may be a center location of a narrow beam. Accordingly, the terminal may calculate distances between the terminal's location and the respective reference locations of the narrow beams.

This is described with reference to FIG. 4 as follows.

The first wide beam 410 may include four different narrow beams 411, 412, 413, and 414. The first service area 411 may be a service area configured by the first narrow beam (beam #1), the second service area 412 may be a service area configured by the second narrow beam (beam #2), the third service area 413 may be a service area configured by the third narrow beam (beam #3), and the fourth service area 414 may be a service area configured by the fourth narrow beam (beam #4).

In this case, the A2 field of the SIB1 may include four different reference locations. The four reference locations may be referred to as a first reference location, a second reference location, a third reference location, and a fourth reference location, respectively. The first reference location may correspond to the first narrow beam, the second reference location may correspond to the second narrow beam, the third reference location may correspond to the third narrow beam, and the fourth reference location may correspond to the fourth narrow beam.

The coordinates of the reference location are assumed to be longitude and latitude for convenience of description. Also, it may be assumed that the longitude and latitude coordinates of the first reference location are (x₁, y₁), those of the second reference location are (x₂, y₂), those of the third reference location are (x₃, y₃), and those of the fourth reference location are (x₄, y₄). Further, assuming that the longitude and latitude of the terminal's own coordinates (or location values) measured using the GPS receiver are (x₀, y₀), then a distance between the terminal and each reference location may be calculated as in Equation 1 below.

$${d}_{i} = \sqrt{{( {x}_{0} - {x}_{i} )}^{2} + {( {y}_{0} - {y}_{i} )}^{2}} \qquad [ Equation 1 ]$$

In Equation 1, dᵢ may be a distance to the i-th reference location, and xᵢ and yᵢ may be a longitude value (or x-axis value) and a latitude value (or y-axis value), respectively, of the i-th reference location. Also, x₀ and y₀ may be the location values of the terminal measured using the GPS receiver.

After calculating the distances between the terminal and the respective reference locations as in Equation 1, the terminal may select a narrow beam corresponding to a reference location having the shortest distance to the terminal. In other words, the terminal may determine that the terminal is located in a narrow beam area having the closest reference location.

Although the above has been described using FIG. 4 as an example, in the case of FIG. 5 as well, the terminal may also determine a narrow beam in which the terminal is located using the same method.

In step S816, the terminal may perform a RACH access procedure with the satellite based on the information on the selected narrow beam. When the terminal transmits a RACH preamble to the satellite in the RACH access procedure of step S816, the RACH preamble corresponding to the selected narrow beam may be transmitted in an RO corresponding to the selected narrow beam. The terminal may initiate the RACH access procedure based on the selected narrow beam by transmitting the RACH preamble to the satellite based on the SIB1. In this case, the terminal may transmit the RACH preamble to the satellite using a beam corresponding to the selected narrow beam. When the base station receives the RACH preamble from the terminal, the base station may identify the narrow beam in which the terminal transmitting the RACH preamble is located based on a sequence or RO of the received RACH preamble. A subsequent RACH access procedure may be the same as the procedure described above with reference to FIG. 3. Accordingly, redundant description is omitted herein.

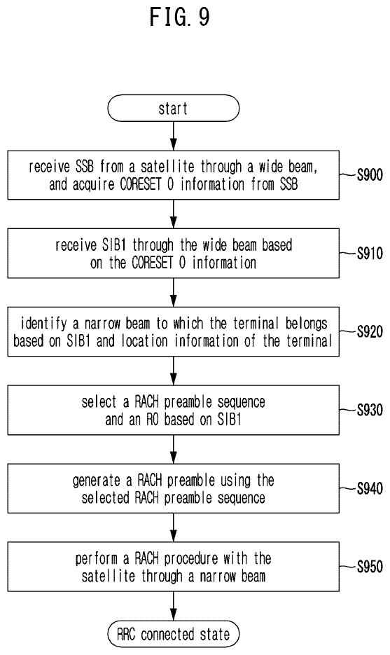

FIG. 9 is a flowchart of a first exemplary embodiment in which a terminal performs a RACH access procedure through a narrow beam of a satellite by receiving a signal broadcast through a wide beam of the satellite in an NTN.

In step S900, the terminal may receive an SSB through a wide beam from the satellite. By receiving the SSB, the terminal may synchronize with the wide beam of the satellite, and may acquire an MIB from a PBCH included in the SSB. The terminal may acquire information on a CORESET 0 based on the acquired MIB.

In step S910, the terminal may receive an SIB1 broadcast by the satellite based on the information on the CORESET 0. Since the SIB1 is received on a PDSCH, the terminal may first receive a DCI on a PDCCH in the CORESET 0. Then, the terminal may receive the SIB1 on the PDSCH based on the DCI received on the PDCCH. The SIB1 may include information related to narrow beams belonging to the wide beam, as described with reference to FIG. 8. In other words, as described above, the SIB1 may include at least one of the A1 field and the A2 field, and at least one of the B1 field and the B2 field. Accordingly, the terminal may identify the number of narrow beams, reference locations of the respective narrow beams, RACH preamble sets used in the respective narrow beams, and ROs or RO groups used in the respective narrow beams, based on the SIB1.

In step S920, the terminal may identify a narrow beam to which the terminal belongs by comparing location information of the terminal measured using the GPS receiver of the terminal and reference locations of the respective narrow beams acquired from the SIB1. The narrow beam to which the terminal belongs may be identified by calculating distances between the reference locations and the location of the terminal based on the scheme described in Equation 1 above.

In step S930, the terminal may select a RACH preamble sequence and an RO based on the SIB1. In other words, since the terminal is able to know the narrow beam to which the terminal belongs through step S920, the terminal may select a RACH preamble set corresponding to the narrow beam to which the terminal belongs among the RACH preamble sets for the respective narrow beams based on the SIB1. The terminal may select a RACH preamble sequence from the selected RACH preamble set. In addition, the terminal may select an RO group corresponding to the narrow beam to which the terminal belongs among RO groups corresponding to the respective narrow beams based on the SIB1, and may select one RO included in the RO group.

In step S940, the terminal may generate a RACH preamble to be transmitted to the satellite through the narrow beam by using the selected RACH preamble sequence.

In step S950, the terminal may perform a RACH access procedure with the satellite through the narrow beam. When performing the RACH access procedure, the terminal may initiate the RACH access procedure by transmitting the generated RACH preamble to the satellite through the narrow beam in the selected RO.

In step S950, when the satellite receives the RACH preamble having the RACH preamble sequence corresponding to the narrow beam in the RO of the specific narrow beam from the terminal, the satellite may identify the narrow beam to which the terminal belongs.

Meanwhile, the method described in FIG. 8 and FIG. 9 may be a method in which an RO and/or a RACH preamble is mapped to each narrow beam. The exemplary embodiment of the present disclosure may be modified as follows so that the terminal and the satellite can identify the narrow beam.

### First Modified Exemplary Embodiment

The base station may represent mapping between a narrow beam identifier (ID) and an RO instead of mapping between an SSB identifier (ID) and an RO. As described in FIG. 4 and/or FIG. 5, beam areas corresponding to the respective narrow beams may be areas served by the corresponding narrow beams. Each of the service areas may be distinguished by a narrow beam ID. Accordingly, the base station may map between a narrow beam ID and an RO and may transmit the mapping to the terminal through the SIB1.

The terminal may identify a narrow beam to which the terminal belongs based on information on reference locations of the narrow beam included in the SIB1 and the location information of the terminal measured through the GPS receiver. Accordingly, the terminal may select an RO corresponding to an ID of the narrow beam to which the terminal belongs among ROs in the RO group included in the SIB1. The terminal may also select a RACH preamble set in the same manner. In this case, mapping between the narrow beam ID and the RO and/or the RACH preamble set may be predefined in a descending order (or ascending order) of the narrow beam IDs or may be configured as one bit in the SIB1.

In other words, the base station may configure mapping between the SSB ID and the RO in the SIB1 to be reinterpreted as described above. Accordingly, the terminal may reinterpret the mapping between the SSB ID and the RO in the SIB1 as mapping between the narrow beam ID and the RO and/or the RACH preamble set based on the information configured by the base station.

### Second Modified Exemplary Embodiment

The base station may add a new parameter delivering a mapping relationship between a narrow beam and an RO and/or a RACH preamble to one of the SIB1 or the SIB19, and may transmit one of the SIB1 or the SIB19 including the added new parameter to the terminal. Accordingly, the terminal may receive the SIB including the new parameter delivering the mapping relationship between the narrow beam and the RO and/or the RACH preamble. In this case, the SIB including the new parameter delivering the mapping relationship between the narrow beam and the RO and/or the RACH preamble may be one of the SIB1 or the SIB19. Accordingly, the terminal may generate a RACH preamble based on the mapping relationship between the narrow beam and the RO and/or the RACH preamble included in the received SIB, and may attempt initial access by transmitting the generated RACH preamble to the satellite through a narrow beam in the corresponding RO. In this case, a method in which the narrow beam ID is allocated in ascending order (or descending order) of reference location information may be predefined or may be configured as one bit of the SIB.

On the other hand, in the present disclosure described in FIG. 8 and FIG. 9, the case where additional information is transmitted through the SIB1 has been assumed and described. However, in the NTN, the information may be added to the SIB19 for terminals communicating with the satellite. Accordingly, the satellite may add the information described in FIG. 8 and/or FIG. 9 to the SIB19. In other words, the A1 field, the A2 field, the B1 field, and/or the B2 field described above may be included in the SIB19. When the fields are included in the SIB19, information on a RACH preamble sequence set or an RO group corresponding to the narrow beam may be obtained by a specific calculation equation based on the narrow beam ID. Here, RACH preamble sequence sets or RO groups corresponding to all narrow beams constituting the wide beam may be a subset of RACH configuration information included in the SIB1.

Meanwhile, in the exemplary embodiment described above, only the case of using the SIB1 has been described, but a case of using the SIB19 may be equally understood. However, the base station may periodically transmit the SIB19 to the terminal, or may transmit the SIB19 to the terminal in response to a request from the terminal. However, since exemplary embodiments of the present disclosure are applied before the terminal performs a RACH access procedure, the case where the SIB19 is received by a request from the terminal may not be used. Accordingly, in the case of operating based on the SIB19, the terminal may receive the SIB19 periodically transmitted (broadcast) by the base station before the RACH access procedure. Information required for the terminal to receive the SIB19 may be provided to the terminal through the SIB1.

In the exemplary embodiment of FIG. 8 and FIG. 9 described above, the case in which both the SSB and the SIB (e.g. SIB1, or SIB1 and SIB19) are transmitted through a wide beam has been described. In an exemplary embodiment described below, a case in which the SSB is transmitted through a wide beam and the SIB is transmitted through a narrow beam is described.

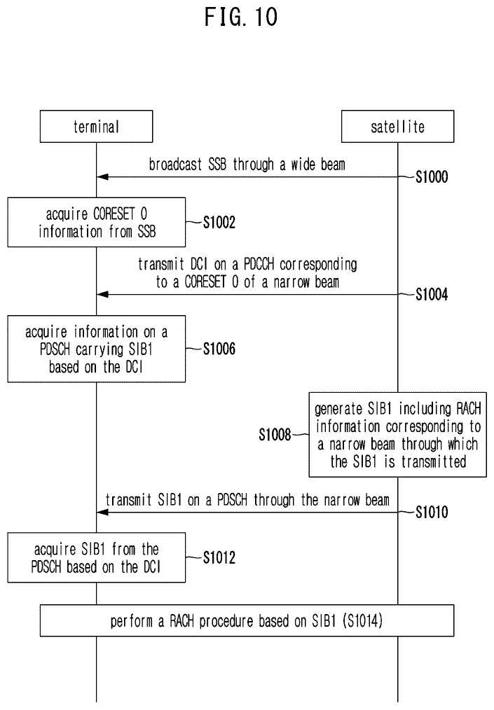

FIG. 10 is a sequence chart illustrating a second exemplary embodiment for a case where a terminal initiates a RACH access procedure through a narrow beam of a satellite based on a signal broadcast through a wide beam of the satellite in an NTN.

Prior to referring to FIG. 10, a terminal may include all or a part of the components of the communication node 200 illustrated in FIG. 2. The terminal may further include various devices for user convenience in addition to the components of the communication node 200 illustrated in FIG. 2. For example, the terminal may further include one or more of various sensors, a camera device, and user interface devices. In addition, the terminal may further include a power supply device such as a battery in addition to the components of the communication node 200 illustrated in FIG. 2.

A satellite illustrated in FIG. 10 may be a satellite that simply amplifies and transmits a signal (or data) transmitted to the terminal, or may be a satellite that reprocesses and amplifies a signal (or data) transmitted to the terminal and then transmits the signal (or data). In addition, the satellite illustrated in FIG. 10 may include all or a part of the components illustrated in FIG. 2. The satellite illustrated in FIG. 10 may further include an interface for processing a feeder link and an ISL described in FIG. 6 and/or FIG. 7. Control operations of the satellite described in FIG. 10 may be directly controlled by a processor of the satellite, or may be controlled by a ground base station (not shown in the drawings), a ground gateway, and/or a specific node of a core network. Hereinafter, for convenience of description, a case where operations of the satellite illustrated in FIG. 10 are controlled by a processor of the satellite is described.

In step S1000, the satellite may transmit an SSB through a wide beam to a service area covered by the wide beam. The SSB may be periodically transmitted. In FIG. 10, the SSB may be understood as an SSB at a specific time among periodically transmitted SSBs. A terminal desiring to access the NTN may receive the SSB transmitted by the satellite using a wide beam in step S1000. The SSB may include a PSS and an SSS as described above and may include a PBCH.

In step S1002, the terminal may acquire downlink synchronization with the satellite by using the SSB received through the wide beam and may acquire a PCI. In addition, the terminal may demodulate and decode the PBCH included in the SSB and may acquire information on a CORESET 0 in which an SIB1 is transmitted.

In step S1004, the satellite may transmit a DCI on a PDCCH corresponding to CORESET 0 by using each narrow beam included in the wide beam. In another embodiment, the satellite may transmit the DCI over the PDCCH corresponding to CORESET 0 using the wide beam over which the SSB is transmitted. In step S1004, the terminal may receive the DCI transmitted on the PDCCH based on the CORESET 0. In this case, CORESET 0 information of the respective narrow beams may all be identical. As illustrated in FIG. 4 and/or FIG. 5, the satellite may transmit a signal to terminals located in service areas configured by the narrow beams by using the respective narrow beams. In addition, since the CORESET 0 information of all narrow beams included in one wide beam is identical, the PDCCH on which the DCI is transmitted may be allocated with identical time-frequency resources for all narrow beams. Accordingly, the terminal may acquire synchronization with the satellite based on the SSB received through the wide beam and may receive the DCI through a narrow beam. The DCI transmitted through the narrow beam may include information on a PDSCH on which an SIB1 is transmitted.

In step S1006, the terminal may acquire information on the PDSCH on which the SIB1 is transmitted based on the received DCI. The information on the PDSCH on which the SIB1 is transmitted may include, for example, a time-frequency resource in which the PDSCH is transmitted and MCS information of data transmitted through the PDSCH. The DCI may further include at least some of the information in Table 1 described above. In addition, since the DCI is transmitted through the narrow beam, the PDSCH on which the SIB1 is transmitted may also be transmitted through the narrow beam.

In step S1008, the satellite may generate the SIB1 including RACH configuration information corresponding to the respective narrow beams belonging to the wide beam. Referring to FIG. 4 described above, this is described as follows.

The service area 410 formed by the first wide beam illustrated in FIG. 4 may include the service areas 411, 412, 413, and 414 formed by four narrow beams. The first narrow beam service area 411 may be a service area covered by the first narrow beam, the second narrow beam service area 412 may be a service area covered by the second narrow beam, the third narrow beam service area 413 may be a service area covered by the third narrow beam, and the fourth narrow beam service area 414 may be a service area covered by the fourth narrow beam.

In other words, the first wide beam may be composed of the first narrow beam, the second narrow beam, the third narrow beam, and the fourth narrow beam. The base station may configure a first RACH preamble set (or RACH preamble sequence set) and a first RO group corresponding to the first narrow beam in the SIB1 transmitted through the first narrow beam, may configure a second RACH preamble set (or RACH preamble sequence set) and a second RO group corresponding to the second narrow beam in the SIB1 transmitted through the second narrow beam, may configure a third RACH preamble set (or RACH preamble sequence set) and a third RO group corresponding to the third narrow beam in the SIB1 transmitted through the third narrow beam, and may configure a fourth RACH preamble set (or RACH preamble sequence set) and a fourth RO group corresponding to the fourth narrow beam in the SIB1 transmitted through the fourth narrow beam.

The first RACH preamble set, the second RACH preamble set, the third RACH preamble set, and the fourth RACH preamble set may be different from each other and may include preamble sequences that do not overlap with each other. In addition, the first RO group, the second RO group, the third RO group, and the fourth RO group may be configured differently and may be configured so as not to overlap with each other.

As a modified exemplary embodiment, when the base station configures the first RACH preamble set, the second RACH preamble set, the third RACH preamble set, and the fourth RACH preamble set to be composed of preamble sequences that do not overlap with each other, the first RO group, the second RO group, the third RO group, and the fourth RO group may be the same RO group. In this case, the base station may identify a narrow beam based on a RACH preamble sequence transmitted by the terminal in a RACH access procedure.

As another modified exemplary embodiment, when the base station configures the first RO group, the second RO group, the third RO group, and the fourth RO group to be composed of ROs that do not overlap with each other, the first RACH preamble set, the second RACH preamble set, the third RACH preamble set, and the fourth RACH preamble set may be configured with the same RACH preamble sequences. In this case, the base station may identify a narrow beam based on an RO in which the terminal transmits a RACH preamble sequence in a RACH access procedure.

Referring again to FIG. 10, step S1008 may be a procedure in which the satellite generates the SIB1 including different RACH configuration information corresponding to respective narrow beams as described above.

In step S1010, the satellite may transmit (or broadcast) the SIB1 corresponding to each narrow beam to the terminal on the PDSCH corresponding to each narrow beam. Time and frequency resources in which the SIB1 is transmitted for respective narrow beams may be identical, but the SIB1 transmitted through respective narrow beams may be composed of different information as described above. In addition, the SIB1 transmitted through respective narrow beams may be transmitted at a preset periodicity. Step S1010 illustrated in FIG. 10 may be an example in which the SIB1 is transmitted or broadcast through a narrow beam at a specific time during its periodic transmission through the narrow beam.

When one wide beam is composed of a plurality of adjacent narrow beams as in FIG. 4, the terminal may receive two or more PDCCHs and/or PDSCHs. In the case of FIG. 4, the terminal may receive the SIB1 through a narrow beam having the strongest signal strength based on the information acquired in step S1006.

As illustrated in FIG. 5, one wide beam may be composed of narrow beams having separate service areas. In such a case where one wide beam has separate service areas, the PDCCH and/or the PDSCH based on the SSB may be transmitted through a CORESET 0 different from that of an adjacent narrow beam.

A case in which the terminal receives two or more PDCCHs and/or PDSCHs when one wide beam is composed of a plurality of adjacent narrow beams as in FIG. 4 is described as follows. It may be assumed that the first wide beam illustrated in FIG. 4 is composed of the first narrow beam, the second narrow beam, the third narrow beam, and the fourth narrow beam. In addition, it may be assumed that a first terminal belongs to the first narrow beam service area 411, a second terminal belongs to the second narrow beam service area 412, a third terminal belongs to the third narrow beam service area 413, and a fourth terminal belongs to the fourth narrow beam service area 414.

In such a case, the first terminal may receive the SIB1 corresponding to the first narrow beam through the first narrow beam. In this case, a reception signal strength of the first narrow beam may be greater than reception signal strengths of the second narrow beam, the third narrow beam, and the fourth narrow beam.

Similarly, the second terminal may receive the SIB1 corresponding to the second narrow beam through the second narrow beam. In this case, a reception signal strength of the second narrow beam may be greater than reception signal strengths of the first narrow beam, the third narrow beam, and the fourth narrow beam.

In addition, the third terminal may receive the SIB1 corresponding to the third narrow beam through the third narrow beam, and the fourth terminal may receive the SIB1 corresponding to the fourth narrow beam through the fourth narrow beam. In other words, each terminal may receive the SIB1 corresponding to the narrow beam to which the terminal belongs through the narrow beam.

In the case of FIG. 5, since CORESET 0 of adjacent narrow beams may be different, the terminal may receive the DCI on a PDCCH based on the CORESET 0 information regardless of reception signal strengths, and may receive the SIB1 transmitted on a PDSCH based on the received DCI.

Referring again to FIG. 10, in step S1012, the terminal may demodulate and decode the SIB1 received through a specific narrow beam (the narrow beam to which the terminal belongs) based on the DCI acquired in step S1006, and when the decoding is successful, the terminal may acquire the SIB1. When the decoding fails, the terminal may perform again from one of step S1000, step S1004, or step S1010.

In step S1012, when the terminal succeeds in decoding the SIB1, the terminal may acquire a RACH preamble set and/or an RO group included in the SIB1. In this case, the RACH preamble set and/or the RO group included in the SIB1 may be a RACH preamble set and/or an RO group to be used for the corresponding narrow beam.

Accordingly, in step S1014, the terminal may generate a RACH preamble based on the SIB1, and a RACH access procedure may be initiated by transmitting the generated RACH preamble to the satellite at the RO based on the SIB1. When transmitting the generated RACH preamble, the terminal may transmit the generated RACH preamble to the satellite by using a beam corresponding to the corresponding narrow beam. In step S1014, when the satellite receives the RACH preamble from the terminal, the satellite may identify the narrow beam to which the terminal belongs based on the RACH preamble and/or the RO.

As described above, according to the exemplary embodiment of FIG. 10, the terminal may operate without a GPS receiver. In other words, without an operation of measuring (or estimating) the location of the terminal, the wide beam and the narrow beam may be identified at each of the terminal and the satellite.

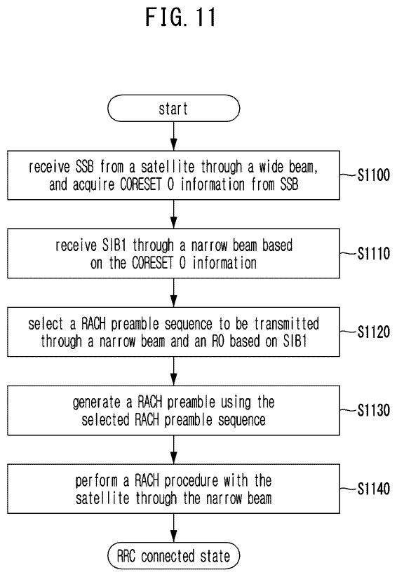

FIG. 11 is a flowchart of a second exemplary embodiment in which a terminal performs a RACH access procedure through a narrow beam of a satellite by receiving a signal broadcast through a wide beam of the satellite in an NTN.

In step S1100, the terminal may receive an SSB through a wide beam from a satellite. By receiving the SSB, the terminal may synchronize with the wide beam of the satellite, and may acquire an MIB from a PBCH included in the SSB. The terminal may acquire information on a CORESET 0 based on the acquired MIB.

In step S1110, the terminal may receive an SIB1 broadcast by the satellite based on the information on the CORESET 0. In this case, the terminal may receive the SIB1 through a narrow beam. Since the SIB1 is received on a PDSCH, the terminal may first receive a DCI on a PDCCH in the CORESET 0, and may receive the SIB1 on the PDSCH based on the DCI received on the PDCCH in the CORESET 0. If the base station transmits a DCI on a PDCCH using a wide beam in CORESET 0, the DCI can be applied commonly to narrow beams included in the wide beam. When the base station transmits the DCI through the PDCCH in the CORESET 0, the base station may configure the DCI for each narrow beam and transmit the DCI. In this case, time-frequency resources of the PDCCH in which the DCI is transmitted may be the same time-frequency resource.

For example, as illustrated in FIG. 4, when one wide beam is composed of adjacent narrow beams, the terminal may receive a DCI having the largest signal strength and may receive an SIB1 on a PDSCH indicated by the DCI.

In another example, as illustrated in FIG. 5, when one wide beam is composed of narrow beams that are not adjacent, the beam through which the terminal receives the SSB and the beam through which the terminal receives the SIB1 may be the same beam. Accordingly, the terminal may receive the SIB1 on the PDSCH based on the received DCI.

The SIB1 received in step S1110 may include different RACH-related information for each narrow beam included in the wide beam. In other words, the SIB1 may include information on a RACH preamble set and/or an RO group corresponding to each narrow beam in which the SIB1 is transmitted. Accordingly, the terminal may acquire information on the RACH preamble set and/or the RO group for the narrow beam based on the SIB1 received in step S1110.

In step S1120, the terminal may select a RACH preamble sequence to be transmitted through a narrow beam and an RO based on the SIB1. The RACH preamble sequence selected by the terminal may be one RACH preamble sequence arbitrarily selected by the terminal among preamble sequences included in the RACH preamble set acquired from the SIB1.

In step S1130, the terminal may generate a RACH preamble by using the selected RACH preamble sequence.

In step S1140, the terminal may perform a RACH access procedure with the satellite through the narrow beam. Initiation of the RACH access procedure may be performed by transmitting the RACH preamble generated in step S1130 using the RO selected in step S1120. When the base station receives the RACH preamble composed of the RACH preamble sequence in the specific RACH preamble set and/or at the specific RO from the terminal, the base station may identify the narrow beam to which the terminal belongs. Since the subsequent RACH access procedure has been described in FIG. 3 above, a redundant description is omitted herein.

In the exemplary embodiments of FIG. 10 and FIG. 11 described above, a method of mapping an RO and/or a RACH preamble to a narrow beam may be modified as follows.

<Modified Example of Mapping an RO and/or a RACH Preamble to a Narrow Beam>

The base station may adjust parameters in RACH-ConfigGeneric of a narrow beam so that a narrow beam ID and an RO are mapped, and may configure an RO of the narrow beam differently. For example, by configuring values such as msg1-FrequencyStart differently for each narrow beam, the RO may be configured differently even for the same SSB ID.

The above modified example may correspond to a case in which different ROs are mapped to respective narrow beams even though IDs of SSBs transmitted by the base station are the same.

Hereinafter, a configuration of resource element groups (REGs) in which a PDCCH is transmitted in the CORESET 0 is described.

As described above, in a wireless communication system, one method for transmitting more data from a transmission node to a reception node is to use a beamforming scheme. The beamforming scheme may be a scheme of transmitting data using multiple-input multiple-output (MIMO) antennas. In the MIMO scheme, the transmission node may transmit data to the reception node through a beam formed by multiplying a precoding matrix with a data vector to be transmitted.

On the other hand, in a wireless communication system, a transmission node may simultaneously transmit data to reception nodes located in different spaces through multiple spatial beams formed by an analog beamforming scheme without using a precoding matrix. The transmission node may also form beams with different shapes and sizes when forming beams in the same area. In other words, beams formed in the same area may be different beams.

In the present disclosure, it should be noted that the term ‘precoding’ should not be interpreted as being limited to digital beamforming but may be interpreted in a comprehensive sense including not only digital beamforming but also analog beamforming.

On the other hand, a transmission node may use different precoding (or beams) for each channel in order to achieve a target performance of a channel for transmitting specific data (or a signal). Therefore, a DMRS transmitted together with specific data may be precoded differently for each channel or may be transmitted through a different beam for each channel. In other words, a DMRS precoded in a different manner for each channel may be transmitted. For example, the transmission node may apply a first precoding scheme to first data and a first DMRS transmitted through a first channel and transmit the first data and the first DMRS to a reception node, and may apply a second precoding scheme to second data and a second DMRS transmitted through a second channel and transmit the second data and the second DMRS to a reception node. In another example, the transmission node may transmit the first data and the first DMRS transmitted through the first channel to the reception node via a first beam, and may transmit the second data and the second DMRS transmitted through the second channel to the reception node via a second beam.

In such a case, the reception node must demodulate the first data received through the first channel using the first DMRS received through the first channel, and must demodulate the second data received through the second channel using the second DMRS received through the second channel. If both the first data received through the first channel and the second data and received through the second channel are demodulated using the first DMRS, channel estimation performance of the second channel may deteriorate due to different precoding schemes (or beams). The opposite case may be the same.

Therefore, in a wireless communication system, a transmission node (e.g. a base station) may need a method for informing a reception node (e.g. a terminal) of information on a precoding scheme (or beam) used for each channel or information on channels for which DMRS can be used and channels for which DMRS cannot be used.

In the present disclosure described below, a method and an apparatus capable of distinguishing DMRS using different precoding (or beams) in a wireless communication system may be provided.

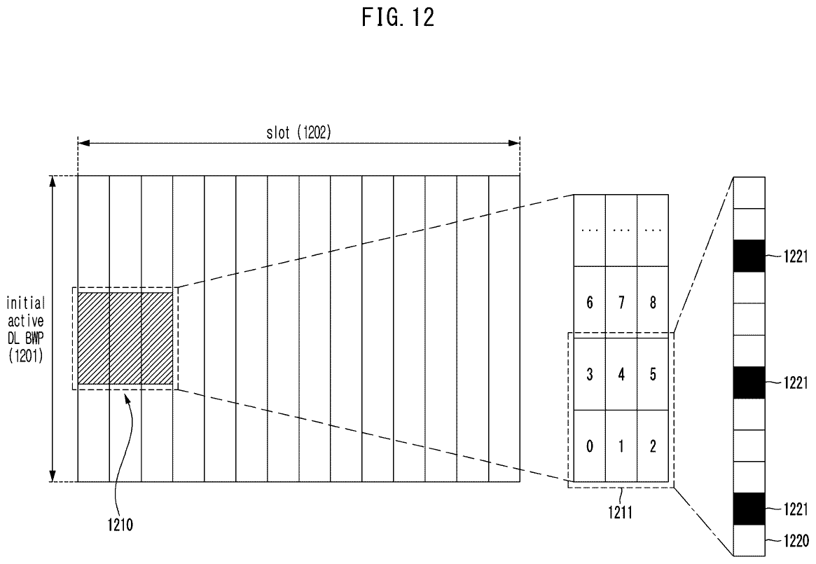

FIG. 12 is a conceptual diagram illustrating a REG-based CORESET 0 in one slot.

Referring to FIG. 12, an initial active downlink (DL) bandwidth part (BWP) 1201 in the frequency domain and one slot 1202 in the time domain are illustrated. The slot 1202 may be composed of 14 OFDM symbols. A CORESET 0 1210 may be allocated to a part of a frequency region in the initial active DL BWP 1201 and may be mapped to three OFDM symbols of the slot in the time domain. Accordingly, a DCI may be transmitted in the CORESET 0 1210 composed of a part of the frequency region in the initial active DL BWP 1201 and three OFDM symbols. Since the DCI is transmitted on a PDCCH, the CORESET 0 1210 may be understood as a resource of the PDCCH.

The CORESET 0 1210 may be composed of a plurality of control channel elements (CCEs) 1211, and one CCE may include six resource element groups (REGs). Generally, an REG-based interleaved mapping may be applied to the CORESET 0, but FIG. 12A assumes a case where the interleaved mapping is not applied for convenience of description.

A plurality of REGs may be included in one OFDM symbol, and each REG may be composed of 12 REs. As illustrated in FIG. 12, one REG may include three DMRSs 1221. Accordingly, information of the DCI transmitted through one REG may be transmitted through only nine REs.

For decoding of the DCI transmitted on the PDCCH in the CORESET 0, the terminal may first perform channel estimation by using the DMRS. As illustrated in FIG. 12, the DMRS may be transmitted together with data transmitted in each corresponding channel for channel estimation when decoding a PBCH and decoding a PDSCH. In this case, the DMRS transmitted on the PDCCH corresponding to CORESET 0 may be assumed to be quasi-co-located (QCLed) with an SS/PBCH block. In other words, it may be assumed that precoding (or beam) of the SS/PBCH block and the PDCCH corresponding to CORESET 0 are the same or similar. Accordingly, when performing channel estimation for decoding the PDCCH corresponding to CORESET 0, the terminal may use channel estimation information obtained from the DMRS of the SS/PBCH block. In addition, when performing channel estimation for decoding the PDCCH by using the DMRS of the PDCCH, the terminal may also use channel estimation information obtained through estimation from the DMRS transmitted together with the SS/PBCH block. In this manner, when the terminal uses a DMRS received from a first channel QCLed with a second channel together with a DMRS of the second channel when performing channel estimation for decoding the second channel before receiving the second channel, performance of channel estimation can be improved.

As the same example, when performing channel estimation for decoding a PDSCH in which the SIB1 is transmitted by using a DMRS received through the PDSCH, the terminal may also use the DMRS received through the PDCCH. In other words, when it is assumed that the DMRS of the PDSCH on which the SIB1 is transmitted is also QCLed with the DMRS of the PDCCH corresponding to CORESET 0 and the DMRS of the SS/PBCH block, the terminal may use channel estimation information of the DMRS transmitted on another channel.

Meanwhile, when the base station transmits each of the SS/PBCH block, the PDCCH corresponding to CORESET 0, and the PDSCH carrying the SIB1, the base station may use different precoding (or beams) to achieve target performance of each channel. For example, when the base station precodes the SS/PBCH block with a first precoder, precodes the PDCCH corresponding to CORESET 0 with a second precoder, and precodes the PDSCH transmitting the SIB1 with a third precoder, the DMRS transmitted through the SS/PBCH block, the DMRS transmitted through the PDCCH corresponding to CORESET 0, and the DMRS transmitted through the PDSCH transmitting the SIB1 may be transmitted after being precoded differently.

The terminal may receive data through each channel together with the DMRS precoded differently for each channel. In this case, when the terminal estimates each channel by using the DMRS of the SS/PBCH block, the DMRS of the PDCCH transmitted in the CORESET 0, and the DMRS of the PDSCH carrying the SIB1, channel estimation performance may be degraded due to the DMRSs precoded in different schemes.

In particular, since the SS/PBCH block, the PDCCH transmitted in the CORESET 0, and the PDSCH carrying the SIB1 are transmitted in procedures performed before the terminal initially accesses the base station, when channel estimation performance is degraded at the terminal, the terminal may become unable to initially access the base station.

Therefore, in the present disclosure described below, when the base station transmits the DMRSs by using different precoding (or beams) when transmitting the SS/PBCH block, the PDCCH corresponding to CORESET 0, and the PDSCH of the SIB1, a method of informing the terminal of availability of channel estimation information of the DMRS of another channel is described. In addition, in the present disclosure described below, a method is described in which the terminal identifies, based on information received from the base station, whether the DMRS received through each channel among the DMRSs of the SS/PBCH block, the PDCCH corresponding to CORESET 0, and the PDSCH of the SIB1 can be used or cannot be used for channel estimation of another channel, and estimates a channel based on the identified result.

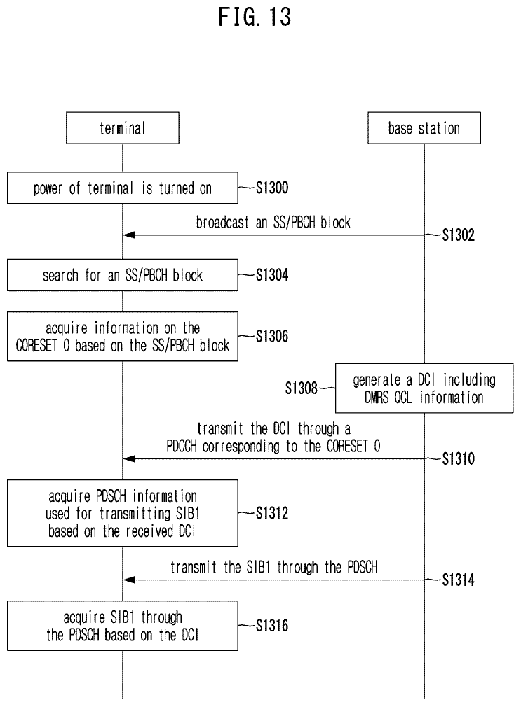

FIG. 13 is a sequence chart illustrating a procedure in which a terminal acquires minimum system information from a base station when power of the terminal is turned on according to an exemplary embodiment of the present disclosure.

Prior to referring to FIG. 13, a terminal may include all or a part of the components of the communication node 200 illustrated in FIG. 2. The terminal may further include various devices for user convenience in addition to the components of the communication node 200 illustrated in FIG. 2. For example, the terminal may further include various sensors, a camera device, and/or user interface devices. In addition, the terminal may further include a power supply device such as a battery in addition to the components of the communication node 200 illustrated in FIG. 2. A base station may also include all or a part of the components of the communication node 200 illustrated in FIG. 2. The base station may further include an interface (e.g. a backhaul interface) for connection with an upper node of the base station in addition to the components of the communication node 200 illustrated in FIG. 2. In addition, when the base station is functionally split, the base station may further include a fronthaul interface for communication with functionally split components.

In step S1300, when the power of the terminal is turned on, the terminal may identify connection configuration of devices within the terminal, and various programs for operation of the terminal may be loaded into the processor 210.

In step S1302, the base station may broadcast an SS/PBCH block. The SS/PBCH block may be transmitted at a predetermined periodicity. It should be noted that step S1302 illustrates a case in which a specific period for transmission of the SS/PBCH block by the base station is exemplified.

In step S1304, the terminal may search for an SS/PBCH block in all frequency bands available to the terminal. In FIG. 13, a case is exemplified in which step S1302 and step S1304 are performed sequentially, but it should be noted that this is for limitation of the drawing and convenience of description. In step S1304, the terminal may first search for an SS to acquire synchronization with the base station. As described above, the SS may include a PSS and an SSS. Thereafter, the terminal may receive a PBCH based on the SS.

In step S1306, the terminal may estimate a channel by using a DMRS received through the PBCH, and may decode an MIB transmitted through the PBCH based on the estimated channel. As described above, the MIB may include SFN, transmission periodicity and number of SSBs, and SIB1-related information. The SIB1-related information may be PDCCH configuration information (e.g. pdcch-ConfigSIB1) including SCS of the SIB1 and PDCCH search space information. The PDCCH search space information may indicate a CORESET 0. Accordingly, the terminal may acquire information on the CORESET 0 in step S1306.

The base station according to the present disclosure may generate a DCI including DMRS QCL information. The QCL information may indicate a QCL relationship among an SS/PBCH block, a PDCCH corresponding to the CORESET 0, and an SIB1 (or SIB19 or system information) received through a PDSCH indicated by the DCI received through the PDCCH.

### First Exemplary Embodiment According to a Method of Forming Beam(s) Per Channel by a Base Station

Operations of a base station and a terminal according to a first exemplary embodiment of the present disclosure are described. In the first exemplary embodiment described below, when only a transmission operation of a base station is described, a terminal may perform an operation of receiving a corresponding channel (or information or data). Conversely, when only an operation of receiving a channel (or information or data) of a terminal is described, a transmission operation of a corresponding base station may be performed.

When a first channel transmitted by the base station is an SS/PBCH block and a second channel is a PDCCH corresponding to CORESET 0, the base station may transmit by applying the same precoding (or beam) to the transmission of the first channel and the second channel, or may transmit by applying different precoding (or beams) to the transmission of the first channel and the second channel.

When the terminal receives the first channel and the second channel, the terminal may assume that the first channel and the second channel are QCLed. Based on the assumption that the first channel and the second channel are QCLed, the terminal may perform channel estimation of the PDCCH and decoding of the PDCCH. When decoding of the PDCCH is successful and there is no additional signaling from the base station, in other words, when a QCL relationship is not indicated from a DCI received through the PDCCH, the terminal may assume that the SS/PBCH block, the PDCCH corresponding to CORESET 0, and a PDSCH carrying an SIB1 (or SIB19 or system information (SI)) indicated by the DCI of the PDCCH are QCLed, and may perform channel estimation and decoding of the PDSCH carrying the SIB1 (or SIB19 or SI).

In addition, the DCI transmitted to the terminal through the PDCCH may explicitly indicate that the SS/PBCH block, the PDCCH corresponding to CORESET 0, and the PDSCH carrying the SIB1 (or SIB19 or SI) are QCLed.

On the other hand, when decoding of the PDCCH fails, the terminal may assume that the first channel and the second channel are not QCLed. Based on the decoding failure of the PDCCH, the terminal may perform channel estimation using only the PDCCH (only the DMRS transmitted through the PDCCH), and then perform decoding of the PDCCH. When decoding of the PDCCH succeeds after channel estimation using only the PDCCH, the terminal may assume that the SS/PBCH block and the SIB1 are not QCLed. Based on the assumption that the SS/PBCH block and the SIB1 (or SIB19 or SI) are not QCLed, the terminal may decode the PDSCH carrying the SIB1 (or SIB19 or SI) based on the DCI received through the PDCCH.

Meanwhile, the DCI received through the PDCCH may explicitly configure a QCL relationship between the first channel, which is the SS/PBCH block, and the PDCCH corresponding to CORESET 0.

### Second Exemplary Embodiment According to a Method of Forming Beam(s) Per Channel by a Base Station

Operations of a base station and a terminal according to a second exemplary embodiment of the present disclosure are described. In the second exemplary embodiment, when only a transmission operation of a base station is described, a terminal may perform an operation of receiving a corresponding channel (or information or data), and when only a reception operation of a terminal is described, a transmission operation of a corresponding base station may be performed.

When a first channel transmitted by the base station is an SS/PBCH block and a second channel is a PDCCH corresponding to CORESET 0, the base station may transmit by applying the same precoding (or beam) to the transmission of the first channel and the second channel, or may transmit by applying different precoding (or beams) to the transmission of the first channel and the second channel. In addition, when a third channel transmitted by the base station is a channel through which an SIB1 (or SIB19 or SI) is transmitted, the third channel may use different precoding (or a beam) from the first channel and the second channel.

When the same precoding (or beam) is used for the first channel and the second channel, and different precoding (or a beam) is used for the third channel from the first channel and the second channel, the base station may signal a QCL relationship between the first channel, the second channel, and the third channel through a DCI. The terminal may identify the QCL relationship configured between the first channel, the second channel, and the third channel from the received DCI. Therefore, the terminal may perform channel estimation and decoding of a PDSCH carrying the SIB1 (or SIB19 or SI) based on the QCL relationship identified from the received DCI. In this case, a DMRS transmitted through the PDSCH may be used for the channel estimation of the PDSCH.

### Third Exemplary Embodiment According to a Method of Forming Beam(s) Per Channel by a Base Station

Operations of a base station and a terminal according to a third exemplary embodiment of the present disclosure are described. In the third exemplary embodiment, when only a transmission operation of a base station is described, a terminal may perform an operation of receiving a corresponding channel (or information or data), and when only a reception operation of a terminal is described, a transmission operation of a corresponding base station may be performed.

When a first channel transmitted by the base station is an SS/PBCH block, a second channel is a PDCCH corresponding to CORESET 0, and a third channel is a PDSCH carrying an SIB1, the base station may use different precoding (or beams) for each channel. In this case, the base station may explicitly inform only a QCL relationship between the second channel and the third channel. In this case, the terminal may implicitly identify a QCL relationship between the first channel and the second channel from channel estimation and decoding results of the PDCCH. For example, the terminal may identify the QCL relationship between the first channel and the second channel based on the first exemplary embodiment described above.

Subsequently, the terminal may perform channel estimation and decoding of the corresponding PDSCH according to the QCL configuration between the second channel and the third channel through the DCI received through the second channel.

In another method, when a QCL field is configured as 2 bits, the base station may explicitly indicate a QCL relationship between the first channel and the second channel and between the second channel and the third channel through the DCI. In another example, the base station may explicitly indicate to the terminal a QCL relationship between the first channel and the third channel and between the second channel and the third channel through the 2-bit QCL field. The terminal may perform channel estimation and decoding of the corresponding PDSCH according to the QCL configuration between the first channel and/or the second channel and the third channel explicitly delivered through the DCI.

In step S1308, the base station may generate a DCI including DMRS QCL information. The DCI generated in step S1308 may have a DCI format 1_0 for indicating a PDSCH carrying an SIB1. In the present disclosure, the DCI format 1_0 for indicating the PDSCH carrying the SIB1 may further include DMRS QCL information as in Table 5 below.

TABLE 5

| Field | Bits |
|---|---|
| Frequency domain resource | Variable |
| assignment | |
| Time domain resource assignment | 4 |
| VRB-to-PRB mapping | 1 |
| MCS | 5 |
| Redundancy version | 2 |
| System information indicator | 1 |
| QCL | 1 |
| Reserved | 15 |

In Table 5, information bits included in the frequency domain resource assignment field may indicate frequency domain resources allocated to the PDSCH, and information bits included in the time domain resource assignment field may indicate time domain resources allocated to the PDSCH. Information bits included in the VBR-to-PRB mapping field may indicate an index (or position) in which a VRB, which is a virtual resource, is mapped to a PRB, which is a physical resource. Information bits included in the MCS field may indicate a modulation and coding scheme, and information bits included in the redundancy version field may indicate initial transmission or retransmission, and may indicate a configuration of coded data retransmitted when a HARQ process is performed. Information bits included in the system information indicator field may be an indicator indicating whether system information has been updated.

In the present disclosure, one reserved bit may be used as the QCL field. In other words, the QCL field may be composed of 1 bit. The QCL field may indicate whether a first channel and a second channel are QCLed. The first channel may be, for example, a PDCCH corresponding to CORESET 0, and the second channel may be a PDSCH indicated by a DCI transmitted through the PDCCH. In another example, the first channel may be an SS/PBCH block, and the second channel may be a PDCCH corresponding to CORESET 0. When the two channels are QCLed, the base station may set an information bit of the QCL field to ‘0’. When the two channels are not QCLed, the base station may set the information bit of the QCL field to ‘1’. Conversely, when the two channels are QCLed, the base station may set the information bit of the QCL field to ‘1’, and when the two channels are not QCLed, the base station may set the information bit of the QCL field to ‘0’.

As another example, a first channel may be an SS/PBCH block, a second channel may be a PDCCH corresponding to CORESET 0, and a third channel may be a PDSCH indicated by a DCI transmitted through the PDCCH. In this case, a 1-bit QCL field may indicate a QCL relationship between the second channel and the third channel. In other words, a QCL relationship between the first channel and the second channel may be implicitly indicated. When a 2-bit QCL field is used, the base station may explicitly indicate a QCL relationship between the first channel and the second channel and a QCL relationship between the second channel and the third channel. In another example in which a 2-bit QCL field is used, the base station may explicitly indicate a QCL relationship between the first channel and the third channel and a QCL relationship between the second channel and the third channel.

### First Exemplary Embodiment of Setting Information Bit of QCL Field

In the DCI format 1_0, according to the first exemplary embodiment, the information bit of the QCL field may be set as follows:

1) When the information bit of the QCL field is set to a value of 0: when the DMRS transmitted through the SS/PBCH block and the DMRS transmitted through the PDCCH corresponding to CORESET 0 are QCLed, the base station may set the information bit of the QCL field to ‘0’.

2) When the information bit of the QCL field is set to a value of 1: when the DMRS transmitted through the SS/PBCH block and the DMRS transmitted through the PDCCH corresponding to CORESET 0 are not QCLed, the base station may set the information bit of the QCL field to ‘1’.

In the first exemplary embodiment of setting the information bit of the QCL field, the bit value may be set in the opposite manner. However, in the present disclosure described below, it is assumed that the information bit of the QCL field is set as described above for convenience of description.

In addition, in step S1308, the base station may add a CRC to the DCI to be transmitted through the PDCCH for error detection, and the CRC may be scrambled with one of various RNTIs depending on the format of the DCI and a purpose of transmitting the DCI. The CRC of the DCI transmitted through the PDCCH corresponding to CORESET 0 may be scrambled with the SI-RNTI as described above. In other words, the base station may scramble the CRC added to the DCI to be transmitted through the PDCCH corresponding to CORESET 0 with the SI-RNTI.

In step S1310, the base station may transmit the PDCCH corresponding to CORESET 0 to the terminal. In step S1310, the terminal may receive the PDCCH corresponding to CORESET 0 from the base station.

In step S1312, the terminal may estimate a channel by using the DMRS received through the PDCCH corresponding to CORESET 0. The terminal may demodulate and decode the DCI based on the estimated channel. The terminal may identify whether the DCI has the DCI format 1_0 received through the PDCCH corresponding to CORESET 0 and whether an error occurs in the DCI received through the PDCCH by descrambling the CRC attached to the DCI with the SI-RNTI. Examples of cases in which a CRC error occurs in the DCI may include the following cases.

First, it may be a case in which the DCI is not normally received due to a channel estimation error. Second, although the channel estimation is properly performed, it may be a case in which a CRC error occurs as a result of descrambling the CRC with the SI-RNTI. Such a case may be when the DCI received through the PDCCH is not the DCI indicating the PDSCH transmitting the SIB1. Third, it may be a case in which the channel is extremely poor and an error occurs in the DCI transmitted through the PDCCH.

In the present disclosure described below, a method to prevent the first case of error is described.

When the DCI received through the PDCCH corresponding to CORESET 0 has no error (when decoding of the DCI is successful), the terminal may acquire information on the PDSCH carrying the SIB1 from the DCI. In the present disclosure, the terminal may estimate the channel for the PDCCH by using only the DMRS received through the PDCCH without using the DMRS received from the PBCH.

In another example, the terminal may estimate the channel for the PDCCH by using both the channel estimation information obtained by using the DMRS received from the SS/PBCH block and the DMRS received through the PDCCH.

When the decoding of the DCI is successful, the terminal may identify a QCL relationship between the DMRS of the PDCCH corresponding to CORESET 0 and the DMRS transmitted through the SS/PBCH block based on the DCI (e.g. DCI format 1_0). When the decoding of the DCI fails, the terminal may perform the operation again from step S1304 or from step S1310.

When the decoding of the DCI is successful, the terminal may identify the QCL field of the received DCI. When the information bit in the QCL field is set to ‘0’, the terminal may recognize that the DMRS of the SS/PBCH and the DMRS of the PDCCH corresponding to CORESET 0 are QCLed, and may interpret that the DMRS of the PDCCH corresponding to CORESET 0 and the SIB1 and DMRS transmitted through the PDSCH indicated by the DCI are QCLed.

On the other hand, when the information bit in the QCL field is set to ‘1’, the terminal may recognize that the DMRS of the SS/PBCH and the DMRS of the PDCCH corresponding to CORESET 0 are not QCLed. Therefore, the terminal may interpret that the DMRS of the PDCCH corresponding to CORESET 0 and the SIB1 and DMRS transmitted through the PDSCH indicated by the DCI are not QCLed.

In step S1314, the base station may transmit the SIB1 to the terminal through the PDSCH. Therefore, in step S1314, the terminal may receive the SIB1 from the base station through the PDSCH based on the DCI successfully decoded.

In step S1316, the terminal may demodulate and decode the SIB1 received through the PDSCH based on the DCI. In this case, when the QCL information included in the DCI is set to ‘0’, in other words, when the DMRS of the PDCCH corresponding to CORESET 0 and the SIB1 and DMRS transmitted through the PDSCH indicated by the DCI transmitted through the PDCCH corresponding to CORESET 0 are QCLed, the terminal may estimate the channel of the PDSCH by using both the DMRS transmitted through the PDSCH and the DMRS of the PDCCH for channel estimation of the PDSCH.

On the other hand, when the QCL information included in the DCI is set to ‘1’, in other words, when the DMRS of the PDCCH corresponding to CORESET 0 and the SIB1 and DMRS transmitted through the PDSCH indicated by the DCI transmitted through the PDCCH corresponding to CORESET 0 are not QCLed, the terminal may estimate the channel by using only the DMRS received through the PDSCH for channel estimation of the PDSCH.

By using one of the above two methods, the terminal may acquire the SIB1 transmitted through the PDSCH. Thereafter, the terminal may perform a random access procedure with the base station (not illustrated in FIG. 13).

### Second Exemplary Embodiment of Setting Information Bit of QCL Field

In step S1308, the base station may set the information bit of the QCL field in the DCI format 1_0 according to the second exemplary embodiment of the present disclosure as follows:

1) When the information bit of the QCL field is set to a value of 0: when the DMRS transmitted through the PDCCH corresponding to CORESET 0 and the DMRS transmitted through the PDSCH indicated by the PDCCH corresponding to CORESET 0 are QCLed, the base station may set the information bit of the QCL field to ‘0’.

2) When the information bit of the QCL field is set to a value of 1: when the DMRS transmitted through the PDCCH corresponding to CORESET 0 and the DMRS transmitted through the PDSCH indicated by the PDCCH corresponding to CORESET 0 are not QCLed, the base station may set the information bit of the QCL field to ‘1’.

In the second exemplary embodiment of setting the information bit of the QCL field, the bit value may be set in the opposite manner. However, in the present disclosure described below, it is assumed that the information bit of the QCL field is set as described above for convenience of description.

In addition, in step S1308, the base station may add a CRC to the DCI to be transmitted through the PDCCH for error detection, and the CRC may be scrambled with one of various RNTIs depending on the format of the DCI and a purpose of transmitting the DCI. The CRC of the DCI transmitted through the PDCCH corresponding to CORESET 0 may be scrambled with the SI-RNTI as described above. In other words, the base station may scramble the CRC added to the DCI to be transmitted through the PDCCH corresponding to CORESET 0 with the SI-RNTI.

In step S1310, the base station may transmit the PDCCH corresponding to CORESET 0 to the terminal. In step S1310, the terminal may receive the PDCCH corresponding to CORESET 0 from the base station.

In step S1312, the terminal may estimate a channel by using the DMRS received through the PDCCH corresponding to CORESET 0. The terminal may demodulate and decode the DCI based on the estimated channel. The terminal may identify whether the DCI has the DCI format 1_0 received through the PDCCH corresponding to CORESET 0 and whether an error occurs in the DCI received through the PDCCH by descrambling the CRC attached to the DCI with the SI-RNTI. When the DCI received through the PDCCH corresponding to CORESET 0 has no error (when decoding of the DCI is successful), the terminal may acquire information on the PDSCH carrying the SIB1 from the DCI. In the present disclosure, the terminal may estimate the channel for the PDCCH by using only the DMRS received through the PDCCH without using the DMRS received from the PBCH.

In another example, the terminal may estimate the channel for the PDCCH by using both the channel estimation information obtained by using the DMRS received from the SS/PBCH block and the DMRS received through the PDCCH.

When the decoding of the DCI is successful, the terminal may identify a QCL relationship between the DMRS of the PDCCH corresponding to CORESET 0 and the DMRS transmitted through the PDSCH indicated by the DCI (e.g. DCI format 1_0). When the decoding of the DCI fails, the terminal may perform the operation again from step S1304 or from step S1310.

When the decoding of the DCI is successful, the terminal may identify the QCL field of the received DCI. When the information bit in the QCL field is set to ‘0’, the terminal may recognize that the DMRS of the PDCCH corresponding to CORESET 0 and the DMRS transmitted through the PDSCH indicated by the DCI are QCLed, and may interpret that the DMRS of the PDCCH corresponding to CORESET 0 and the SIB1 and DMRS transmitted through the PDSCH indicated by the DCI are QCLed.

On the other hand, when the information bit in the QCL field is set to ‘1’, the terminal may recognize that the DMRS of the PDCCH corresponding to CORESET 0 and the DMRS transmitted through the PDSCH indicated by the DCI are not QCLed. Therefore, the terminal may interpret that the DMRS of the PDCCH corresponding to CORESET 0 and the SIB1 and DMRS transmitted through the PDSCH indicated by the DCI are not QCLed.

In step S1314, the base station may transmit the SIB1 to the terminal through the PDSCH. Therefore, in step S1314, the terminal may receive the SIB1 from the base station through the PDSCH based on the DCI successfully decoded.

In step S1316, the terminal may demodulate and decode the SIB1 received through the PDSCH based on the DCI. In this case, when the QCL information included in the DCI is set to ‘0’, in other words, when the DMRS of the PDCCH corresponding to CORESET 0 and the SIB1 and DMRS transmitted through the PDSCH indicated by the DCI transmitted through the PDCCH corresponding to CORESET 0 are QCLed, the terminal may estimate the channel of the PDSCH by using both the DMRS transmitted through the PDSCH and the DMRS of the PDCCH for channel estimation of the PDSCH.

On the other hand, when the QCL information included in the DCI is set to ‘1’, in other words, when the DMRS of the PDCCH corresponding to CORESET 0 and the SIB1 and DMRS transmitted through the PDSCH indicated by the DCI transmitted through the PDCCH corresponding to CORESET 0 are not QCLed, the terminal may estimate the channel by using only the DMRS received through the PDSCH for channel estimation of the PDSCH.

By using one of the above two methods, the terminal may acquire the SIB1 transmitted through the PDSCH. Thereafter, the terminal may perform a random access procedure with the base station (not illustrated in FIG. 13).

### Third Exemplary Embodiment of Setting Information Bit of QCL Field

Operations of a base station and a terminal in a third exemplary embodiment for setting an information bit of a QCL field are described below.

When a first channel transmitted by the base station is an SS/PBCH block, a second channel is a PDCCH corresponding to CORESET 0, and a third channel is a PDSCH through which an SIB1 is transmitted, the base station may use different precoding (or beams) for each channel. In this case, the base station may explicitly indicate only a QCL relationship between the second channel and the third channel through a DCI. When only the QCL relationship between the second channel and the third channel is explicitly indicated, the terminal may identify a QCL relationship between the first channel and the second channel based on the method of the first exemplary embodiment according to the method of forming beam(s) per channel by the base station described above. In other words, the terminal may implicitly identify the QCL relationship between the first channel and the second channel from channel estimation and decoding results of the PDCCH. In addition, the terminal may perform channel estimation and decoding of the corresponding PDSCH according to the QCL configuration between the second channel and the third channel explicitly indicated by the DCI.

When, as described above, the QCL field is configured as 2 bits, the base station may indicate, using the 2-bit QCL field, a QCL relationship between the first channel and the second channel and a QCL relationship between the second channel and the third channel, or may indicate a QCL relationship between the first channel and the third channel and a QCL relationship between the second channel and the third channel.

Therefore, the terminal may perform channel estimation and decoding of the PDSCH according to a QCL configuration between the first channel and the third channel or between the second channel and the third channel based on the 2-bit QCL field.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving a synchronization signal block (SSB) from a satellite through a first beam including two or more narrow beams;
receiving system information (SI) through the first beam based on the received SSB;
identifying a first narrow beam in which the terminal is located among the two or more narrow beams based on first information included in the received SI; and
initiating a random access channel (RACH) procedure based on initial access information of the first narrow beam included in the SI.

2. The method of claim 1, wherein the first information includes at least one of: a number of the two or more narrow beams included in the first beam, or a reference location corresponding to each of the two or more narrow beams included in the first beam.

3. The method of claim 2, wherein the reference location is represented by center coordinates of a service area formed by each of the two or more narrow beams.

4. The method of claim 1, wherein the initial access information includes at least one of: a RACH preamble set or a RACH occasion (RO) group available for each of the two or more narrow beams.

5. The method of claim 4, wherein RACH preamble sets respectively corresponding to the two or more narrow beams include different RACH preamble sequences, and RO groups respectively corresponding to the two or more narrow beams include different RO resources.

6. The method of claim 4, wherein the initiating of the RACH procedure further comprises:
selecting a RACH preamble sequence from a RACH preamble set corresponding to the first narrow beam; and
transmitting a RACH preamble generated using the selected random RACH preamble sequence to the satellite in one RO of a RO group corresponding to the first narrow beam.

7. The method of claim 1, wherein the SI is one of a system information block 1 (SIB1) or a system information block 19 (SIB19).

8. The method of claim 1, further comprising: estimating a location of the terminal based on information received from a plurality of satellites of a global positioning system (GPS),
wherein the identifying of the first narrow beam comprises:
comparing reference locations respectively corresponding to the two or more narrow beams included in the first information with the estimated location of the terminal; and
identifying a narrow beam corresponding to a reference location closest to the location of the terminal as the first narrow beam.

9. A method of a terminal, comprising:
receiving a synchronization signal block (SSB) from a satellite through a first beam including two or more narrow beams;
receiving system information (SI) through a first narrow beam having a greatest reception signal strength among the two or more narrow beams based on the received SSB; and
initiating a random access channel (RACH) procedure based on initial access information of the first narrow beam included in the received SI.

10. The method of claim 9, wherein the initial access information includes at least one of: a RACH preamble set or a RACH occasion (RO) group available for each of the two or more narrow beams.

11. The method of claim 9, wherein RACH preamble sets respectively corresponding to the two or more narrow beams include different RACH preamble sequences, and RO groups respectively corresponding to the two or more narrow beams include different RO resources.

12. The method of claim 9, wherein the initiating of the RACH procedure further comprises:
selecting a RACH preamble sequence from a RACH preamble set corresponding to the first narrow beam; and
transmitting a RACH preamble generated using the selected random RACH preamble sequence to the satellite in one RO of a RO group corresponding to the first narrow beam.

13. A terminal comprising at least one processor, wherein the at least one processor causes the terminal to perform:
receiving a synchronization signal block (SSB) from a satellite through a first beam including two or more narrow beams;
receiving system information (SI) through the first beam based on the received SSB;
identifying a first narrow beam in which the terminal is located among the two or more narrow beams based on first information included in the received SI; and
initiating a random access channel (RACH) procedure based on initial access information of the first narrow beam included in the SI.

14. The terminal of claim 13, wherein the first information includes at least one of: a number of the two or more narrow beams included in the first beam, or a reference location corresponding to each of the two or more narrow beams included in the first beam.

15. The terminal of claim 14, wherein the reference location is represented by center coordinates of a service area formed by each of the two or more narrow beams.

16. The terminal of claim 13, wherein the initial access information includes at least one of: a RACH preamble set or a RACH occasion (RO) group available for each of the two or more narrow beams.

17. The terminal of claim 16, wherein RACH preamble sets respectively corresponding to the two or more narrow beams include different RACH preamble sequences, and RO groups respectively corresponding to the two or more narrow beams include different RO resources.

18. The terminal of claim 16, wherein in the initiating of the RACH procedure, the at least one processor further causes the terminal to perform:
selecting a RACH preamble sequence from a RACH preamble set corresponding to the first narrow beam; and
transmitting a RACH preamble generated using the selected random RACH preamble sequence to the satellite in one RO of a RO group corresponding to the first narrow beam.

19. The terminal of claim 13, wherein the SI is one of a system information block 1 (SIB1) or a system information block 19 (SIB19).

20. The terminal of claim 13, wherein the at least one processor further causes the terminal to perform: estimating a location of the terminal based on information received from a plurality of satellites of a global positioning system (GPS), and in the identifying of the first narrow beam, the at least one processor further causes the terminal to perform:
comparing reference locations respectively corresponding to the two or more narrow beams included in the first information with the estimated location of the terminal; and
identifying a narrow beam corresponding to a reference location closest to the location of the terminal as the first narrow beam.
